(19) United States
(12) Patent Application Publication
(10) Pub. No.: US 2024/0054276 A1
(43) Pub. Date: Feb. 15, 2024

(54) MANUFACTURING METHOD OF SEMICONDUCTOR DEVICE

(71) Applicant: SAMSUNG ELECTRONICS CO., LTD., SUWON-SI (KR)

(72) Inventors: SUBIN KIM, SUWON-SI (KR); JUNSU JEON, SUWON-SI (KR); JAEHYUN KANG, SUWON-SI (KR); BYUNGMOO KIM, SUWON-SI (KR); JOONGWON JEON, SUWON-SI (KR)

(21) Appl. No.: 18/341,142

(22) Filed: Jun. 26, 2023

(30) Foreign Application Priority Data
Aug. 9, 2022 (KR) 10-2022-0099430

(51) Int. Cl. G06F 30/398; G06F 30/392; G06F 30/394

(52) U.S. Cl. CPC G06F 30/398; G06F 30/392; G06F 30/394; G06F 2119/18

(57) ABSTRACT

A method of manufacturing a semiconductor device includes designing a semiconductor device layout using a design rule manual (DRM), in which design rules are recorded, and performing failure evaluation of a failure including at least one gate structure failure of a semiconductor device manufactured using the designed semiconductor device layout. The method further includes updating the DRM by updating the design rules recorded in the DRM, based on a result of the failure evaluation, redesigning the semiconductor device layout using the updated DRM, and manufacturing the semiconductor device using the redesigned semiconductor device layout.

### CROSS-REFERENCE TO RELATED APPLICATION

This application is based on and claims priority under 35 U.S.C. § 119 to Korean Patent Application No. 10-2022-0099430, filed on Aug. 9, 2022 in the Korean Intellectual Property Office, the disclosure of which is incorporated by reference herein in its entirety.

### TECHNICAL FIELD

Embodiments of the inventive concept relate to a manufacturing method of a semiconductor device, and more particularly, to a manufacturing method of a semiconductor device capable of preventing or reducing failures that may occur in the manufacturing process of the semiconductor device.

### DISCUSSION OF RELATED ART

As advances are made in technology, down-scaling of a semiconductor device is under development at a rapid speed. Accordingly, the sizes of components of the semiconductor device and the distance between components may decrease.

### SUMMARY

Embodiments of the inventive concept provide a manufacturing method of a semiconductor device capable of preventing or reducing the occurrence of failures in the manufacturing method.

A method of manufacturing a semiconductor device includes designing a semiconductor device layout using a design rule manual (DRM), in which design rules are recorded, performing evaluation of a failure including at least one gate structure failure of a semiconductor device manufactured using the designed semiconductor device layout, updating the DRM by updating the design rules recorded in the DRM, based on a result of the failure evaluation, redesigning the semiconductor device layout using the updated DRM, and manufacturing the semiconductor device using the redesigned semiconductor device layout.

A method of manufacturing a semiconductor device includes designing a semiconductor device layout using a design rule manual (DRM), in which design rules are recorded, manufacturing the semiconductor device by performing wafer processing using the designed semiconductor device layout, performing a test of inspecting electrical characteristics of the manufactured semiconductor device, performing a failure evaluation of a break of a gate dielectric layer, a burn of an active region, or a burn of a gate electrode, which are included in the semiconductor device, based on a result of the test of the manufactured semiconductor device, updating the DRM by updating the design rules recorded in the DRM based on the result of the failure evaluation, redesigning the semiconductor device layout using the updated DRM, and manufacturing the semiconductor device using the redesigned semiconductor device layout.

A method of manufacturing a semiconductor device includes designing a semiconductor device layout including a substrate including an active region defined by a device isolation layer, a pair of first impurity regions and a second impurity region arranged apart from each other on a portion of an upper side of the substrate, a gate electrode arranged on the active region between the pair of first impurity regions, a gate dielectric layer arranged between the active region and the gate electrode, and a wiring structure including a plurality of wiring patterns and a plurality of wiring vias, using a design rule manual (DRM) in which design rules are recorded. The method further includes manufacturing a semiconductor device by performing a simulation using the designed semiconductor device layout, performing a failure evaluation of a break of a gate dielectric layer, a burn of an active region, or a burn of a gate electrode, which are included in the semiconductor device manufactured using the simulation, updating the DRM by changing regulations specified in the design rules recorded in the DRM, based on a result of the failure evaluation, redesigning the semiconductor device layout using the updated DRM, and manufacturing the semiconductor device by performing wafer processing using the redesigned semiconductor device layout. The plurality of wiring patterns include a plurality of first wiring patterns arranged at a first vertical level, a plurality of second wiring patterns arranged at a second vertical level that is higher than the first vertical level, a plurality of third wiring patterns arranged at a third vertical level that is higher than the second vertical level, and a plurality of fourth wiring patterns arranged at a fourth vertical level that is higher than the third vertical level. The plurality of first wiring patterns include a gate wiring pattern electrically connected to the gate electrode, a first adjacent wiring pattern adjacent to the gate wiring pattern, and a first connection wiring pattern arranged between the fourth wiring patterns and the second impurity region and configured to electrically connect the fourth wiring patterns to the second impurity region. The plurality of second wiring patterns include a second adjacent wiring pattern arranged between the first adjacent wiring pattern and the fourth wiring patterns and configured to electrically connect the fourth wiring patterns to the first adjacent wiring pattern, and a second connection wiring pattern arranged between the fourth wiring patterns and the second impurity region and configured to electrically connect the fourth wiring patterns to the second impurity region. The plurality of third wiring patterns include a target wiring pattern arranged between the first adjacent wiring pattern and the fourth wiring patterns and configured to electrically connect the fourth wiring patterns to the first adjacent wiring pattern, and a third connection wiring pattern arranged between the fourth wiring patterns and the second impurity region and configured to electrically connect the fourth wiring patterns to the second impurity region.

### BRIEF DESCRIPTION OF THE DRAWINGS

The above and other features of the present inventive concept will become more apparent by describing in detail embodiments thereof with reference to the accompanying drawings, in which:

FIGS. 1A through 1D are flowcharts of a manufacturing method of a semiconductor device, according to embodiments;

FIG. 2 is a flowchart of a manufacturing method of a semiconductor device, according to an embodiment;

FIG. 3 is a flowchart of a manufacturing method of a semiconductor device, according to an embodiment;

FIGS. 4A, 4B, and 5A through 5D are cross-sectional views of a manufacturing method of a semiconductor device, and cross-sectional views of semiconductor devices, according to embodiments;

FIGS. 6, 7, and 8 are cross-sectional views of a manufacturing method of semiconductor devices, and cross-sectional views of semiconductor devices, according to embodiments;

FIGS. 9A through 9C and 10 are cross-sectional views of a manufacturing method of a semiconductor device, according to embodiments; and

FIGS. 11 and 12 are cross-sectional views of a manufacturing method of a semiconductor device, according to embodiments.

### DETAILED DESCRIPTION OF THE EMBODIMENTS

Embodiments of the present inventive concept will be described more fully hereinafter with reference to the accompanying drawings. Like reference numerals may refer to like elements throughout the accompanying drawings.

It will be understood that the terms “first,” “second,” “third,” etc. are used herein to distinguish one element from another, and the elements are not limited by these terms. Thus, a “first” element in an embodiment may be described as a “second” element in another embodiment.

It should be understood that descriptions of features or aspects within each embodiment should typically be considered as available for other similar features or aspects in other embodiments, unless the context clearly indicates otherwise.

As used herein, the singular forms “a”, “an” and “the” are intended to include the plural forms as well, unless the context clearly indicates otherwise.

Herein, when two or more elements or values are described as being substantially the same as or about equal to each other, it is to be understood that the elements or values are identical to each other, the elements or values are equal to each other within a measurement error, or if measurably unequal, are close enough in value to be functionally equal to each other as would be understood by a person having ordinary skill in the art. For example, the term “about” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” may mean within one or more standard deviations as understood by one of the ordinary skill in the art. Further, it is to be understood that while parameters may be described herein as having “about” a certain value, according to exemplary embodiments, the parameter may be exactly the certain value or approximately the certain value within a measurement error as would be understood by a person having ordinary skill in the art.

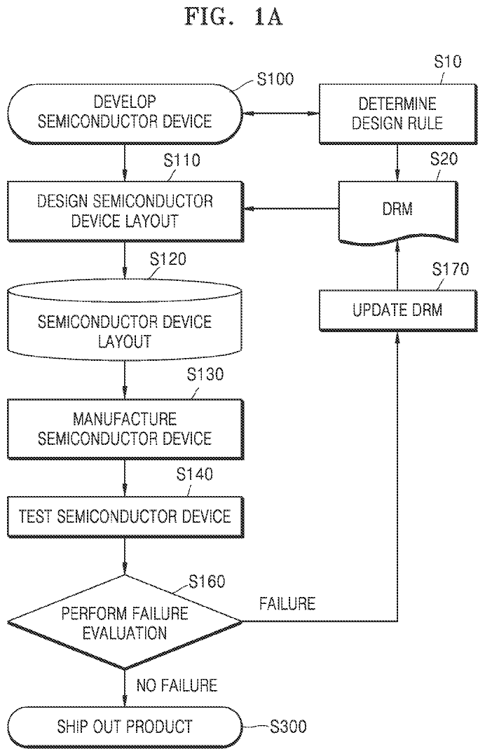

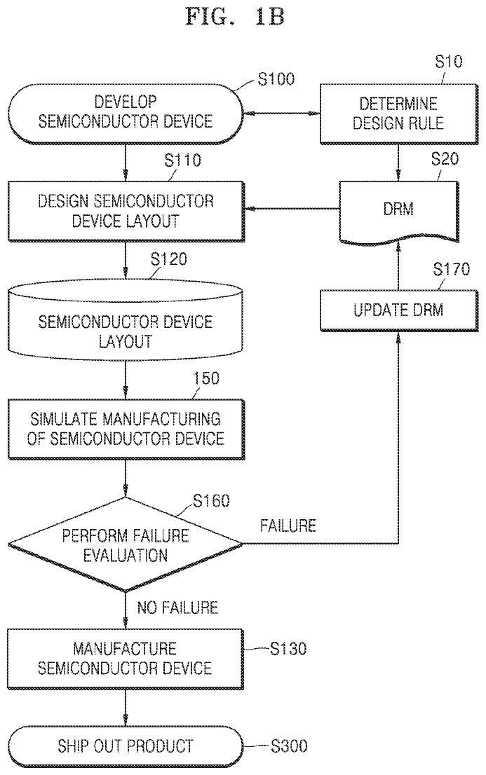

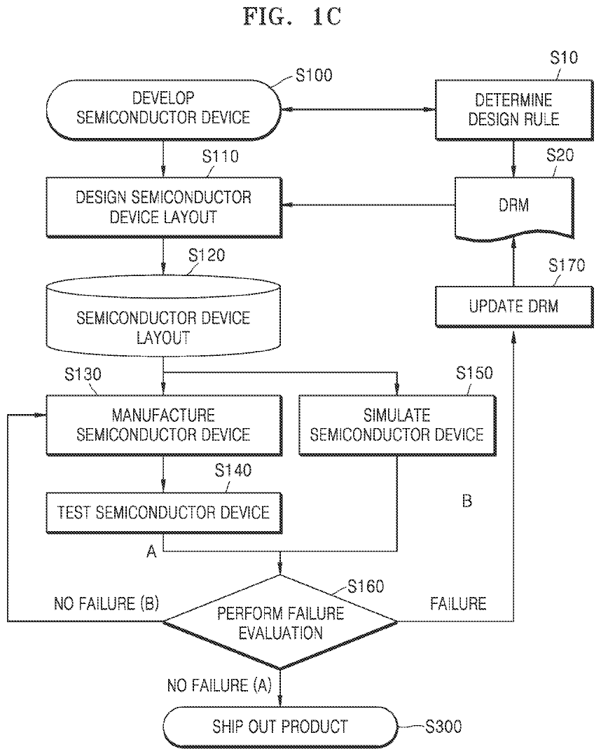

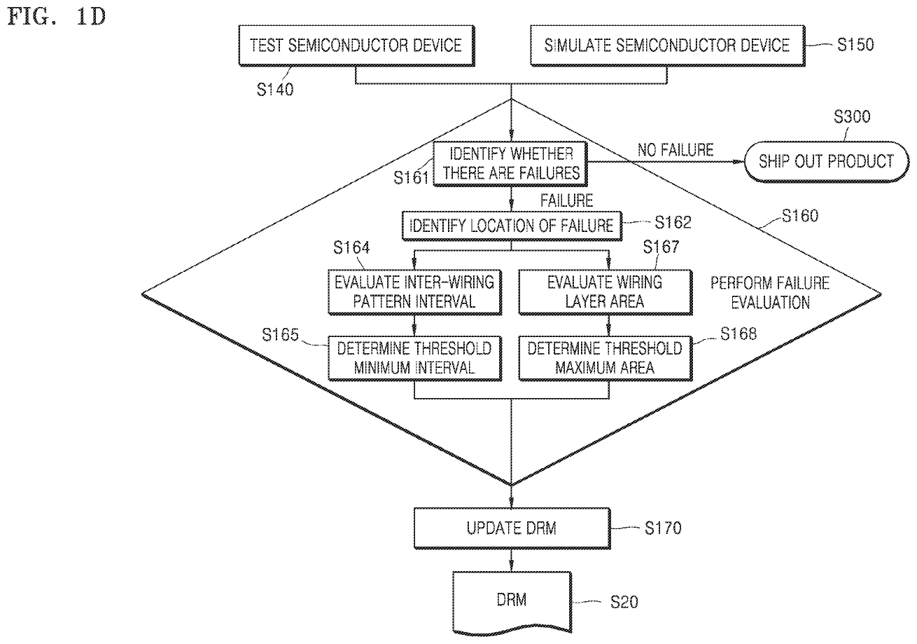

FIGS. 1A through 1D are flowcharts of a manufacturing method of a semiconductor device, according to embodiments.

Referring to FIG. 1A, a design rule is determined (S10). After the design rule is determined (S10), a semiconductor device to which the design rule is applied is developed (S100). In some embodiments, determination of the design rule (S10) may be performed together with a process of developing a semiconductor device (S100). The design rule may be determined based on a minimum line width indicating the resolution limit in photolithography technology. For example, the design rule may specify a rule in the same layer, such as minimum values of widths of a configuration (line widths), the spacing between components, and areas of the components. For example, the design rule may further specify rules between components arranged between different layers, such as the degrees of enclosure, extension, and overlap. The rules specified in the design rule, which are described above, are not limited thereto. For example, the design rule may further specify various rules depending on a semiconductor device to be developed.

The determined design rule may be recorded or stored in a design rule manual (DRM) S20. The semiconductor device layout may be designed based on the DRM S20 (S110). The DRM S20 may provide a guideline for designing the semiconductor device layout. Because a semiconductor device development engineer may design the semiconductor device layout based on the design rule recorded in the DRM S20, there may be restrictions on designing the semiconductor device layout when there are many rules specified in the design rule. For example, the DRM S20 may store the design rule, in which regulations are specified, that is, the design rule in which relatively few regulations are specified.

The semiconductor device may be manufactured using the designed semiconductor device layout S120 (S130). For example, by forming a plurality of masks for manufacturing a semiconductor device, based on the designed semiconductor device layout S120, and performing a wafer process using the plurality of masks, the semiconductor device may be manufactured.

Thereafter, the manufactured semiconductor device may be tested (S140). Testing of the manufactured semiconductor device (S140) may include, for example, tests for inspecting electrical characteristics of the semiconductor device, but is not limited thereto. For example, the testing of the manufactured semiconductor device (S140) may include all of performing destructive inspection and/or non-destructive inspection performed during or after manufacturing the semiconductor device.

Failure evaluation may be performed to identify whether a failure has occurred in the semiconductor device from the test result (S160). The failure evaluation of the manufactured semiconductor device may include a process of checking whether a failure has occurred in the semiconductor device by performing a failure analysis, and when a failure has occurred, identifying a location of the failure and evaluating the regulation specified in the design rule, and thereafter, determining the changed regulation.

When there is no failure in the semiconductor device, the completed semiconductor device may be shipped out as a product (S300). Alternatively, when there is no failure in the semiconductor device, the semiconductor device may be mass produced using the designed semiconductor device layout S120 and shipped out as a product (S300).

Causes of a failure occurring in the semiconductor device may vary, and methods of removing the failure may vary depending on the causes. Although only failures related to regulations specified in the design rule are described, it is to be understood that separate evaluation methods and removal methods may be performed for failures related to other causes.

For example, the failures that may occur in the semiconductor device may be a gate dielectric layer break, a channel region (active region) burn, or a gate electrode burn. In some embodiments, The channel region burn and the gate electrode burn may result from overheating of these respective components that results in damage to the components. The gate dielectric layer break, the channel region burn, and the gate electrode burn may be referred to as gate structure failure. For example, the failure evaluation of the manufactured semiconductor device may be related to failures including the gate structure failure.

When a failure occurs in the manufactured semiconductor device, the DRM S20 may be updated based on a result of the failure evaluation (S170). In other words, the design rule updated by changing the design rule recorded in the DRM S20 may be stored in the DRM S20. For example, when a failure occurs in the manufactured semiconductor device, a location of failure may be identified and an evaluation on regulations specified in the design rule may be performed, and then, the design rule may be updated by changing the regulation, and a DRM update storing the updated result in the DRM S20 may be performed (S170). A history, in which the design rule has been updated, may be recorded in the DRM S20. For example, the design rule, which has been determined and updated the first time, may be recorded altogether in the DRM S20.

Thereafter, after the semiconductor device layout is redesigned or corrected based on the updated DRM S20 (S110), the modified semiconductor device may be manufactured (S130), and the manufactured semiconductor device may be shipped out as a product (S300). In some embodiments, testing S140 and failure evaluation S160 of the semiconductor device manufactured based on the updated DRM 20 may be performed again.

Referring to FIG. 1B, after the design rule is determined (S10), developing a semiconductor device, to which the design rule is applied, may be performed (S100). In some embodiments, determination of the design rule may be performed together (S10) in a process of performing semiconductor device development (S100). The determined design rule may be recorded or stored in the DRM S20.

The semiconductor device layout may be designed based on the DRM S20 (S110). A simulation of manufacturing a semiconductor device may be performed using the designed semiconductor device layout S120 (S150). In the process of performing a simulation of manufacturing a semiconductor device, a test on a semiconductor device manufactured by simulation and a test of a semiconductor device during the process of manufacturing by simulation may be performed together.

Thereafter, the failure evaluation may be performed to identify whether a failure has occurred in the semiconductor device manufactured by the simulation (S160). The failure evaluation of the semiconductor device manufactured by the simulation may include a process of checking whether a failure has occurred in the semiconductor device, and when there is a failure, identifying a location of the failure, evaluating the regulation specified in the design rule, and thereafter, determining the changed regulation.

When there is no failure in the semiconductor device manufactured by the simulation, the semiconductor device may be manufactured/mass produced (S130) using the designed semiconductor device layout S120 and shipped out as a product (S300).

When a failure occurs in the semiconductor device manufactured by the simulation, the DRM S20 may be updated (S170). For example, when a failure occurs in a semiconductor device manufactured by the simulation, the location of the failure may be identified, the regulation specified in the design rule may be evaluated, the design rule for changing regulations may be updated, and the DRM S20 may be updated to store the updated result in the DRM S20 (S170).

In some embodiments, the simulation of manufacturing a semiconductor device based on the updated DRM 20 may be performed (S150) and failure evaluation may be performed (S160) again.

Referring to FIG. 1C, after the design rule is determined (S10), a semiconductor device, to which the design rule is applied, may be developed (S100). In some embodiments, the design rule may be determined (S10) also in a process of developing semiconductor device (S100).

The determined design rule may be recorded or stored in the DRM S20. The semiconductor device layout may be designed based on the DRM S20 (S110). The semiconductor device may be manufactured using the designed semiconductor device layout S120 (S130). Thereafter, the manufactured semiconductor device may be tested (S140). The failure evaluation may be performed to identify whether a failure has occurred in the semiconductor device as the test result (S160).

When there is no failure in the semiconductor device, the completed semiconductor device may be shipped out as a product (S300). Alternatively, when there is no failure in the semiconductor device, the semiconductor device may be mass produced using the designed semiconductor device layout S120 and shipped out as a product (S300).

In some embodiments, instead of manufacturing the semiconductor device (S130), a simulation of manufacturing the semiconductor device using the designed semiconductor device layout (S120) may be performed (S150). Alternatively, in some embodiments, apart from manufacturing (S130) and testing (S140) a semiconductor device, a simulation of manufacturing a semiconductor device using the designed semiconductor device layout S120 may be performed altogether (S150). Thereafter, it may be determined whether a failure has occurred in the semiconductor device manufactured by the simulation, or the failure evaluation may be performed (S160).

When a failure occurs in the manufactured semiconductor device and/or when a failure occurs in the semiconductor device manufactured by simulation, the DRM S20 may be updated (S170). For example, when a failure occurs in a manufactured semiconductor device or a semiconductor device manufactured by the simulation, the location of the failure may be identified, the regulation specified in the design rule may be evaluated, the design rule for changing regulation may be updated, and the DRM S20 may be updated to store the updated result in the DRM S20 (S170).

Thereafter, after the semiconductor device layout is redesigned or corrected based on the updated DRM S20 (S110), the modified semiconductor device may be manufactured (S130) by performing wafer processing, and the manufactured semiconductor device may be shipped out as a product (S300).

In some embodiments, testing on a semiconductor device manufactured based on the updated DRM 20 (S140), and/or simulation of manufacturing a semiconductor device (S150), and the failure evaluation (S160), may be performed again.

Referring to FIG. 1D, after testing the manufactured semiconductor device (S140), and/or performing a simulation of manufacturing the semiconductor device (S150), it may be determined whether a failure has occurred in the semiconductor device (the failure evaluation may be performed (S160)).

First, whether a failure has occurred in the semiconductor device may be identified (the failure evaluation may be verified) (S161). When there is no failure in the semiconductor device, the completed semiconductor device may be shipped out as a product, or the semiconductor device may be mass produced and shipped out as a product (S300).

The location of the failure may be identified (S162). For example, the failures that may occur in the semiconductor device may be a gate dielectric layer break, a channel region (active region) burn, or a gate electrode burn. After identifying the location of the failure that has occurred in the semiconductor device (S162), at the location of the failure, an inter-wiring pattern spacing evaluation (S164), and/or a wiring layer area evaluation (S167), may be performed. For example, the inter-wiring pattern spacing evaluation (S164) may be inclusively performed by considering a spacing between the location of the failure or a wiring pattern connected to the location of the failure, and another wiring pattern adjacent to the wiring pattern, whether the other wiring pattern is electrically floating during the manufacturing process of the semiconductor device, etc. For example, the wiring layer area evaluation (S167) may be inclusively performed by considering whether the other wiring pattern adjacent to the location of the failure or a wiring pattern connected to the location of the failure is electrically floating during the manufacturing process of the semiconductor device, an area of the other wiring pattern adjacent thereto, etc.

After the inter-wiring pattern spacing evaluation is performed (S164), when it is determined that a spacing between the location of the failure or a wiring pattern connected to the location of the failure, and another wiring pattern adjacent thereto is excessively close, a threshold minimum distance between adjacent wiring patterns may be determined (S165). After the wiring layer area evaluation is performed (S167), when it is determined that the area of another wiring pattern adjacent to the location of the failure or adjacent to a wiring pattern connected to the location of the failure is excessively large and there is a wiring pattern which determines a threshold maximum area of the adjacent wiring pattern or has a greater area than the threshold maximum area, a bridge pattern connected between wiring patterns at lower vertical levels than a wiring pattern having a greater area than the threshold maximum area may be additionally provided (S168).

When the threshold minimum distance and/or the threshold maximum area are determined, the DRM S20 may be updated (S170). In other words, the design rule updated by changing the design rule recorded in the DRM S20 may be stored in the DRM S20.

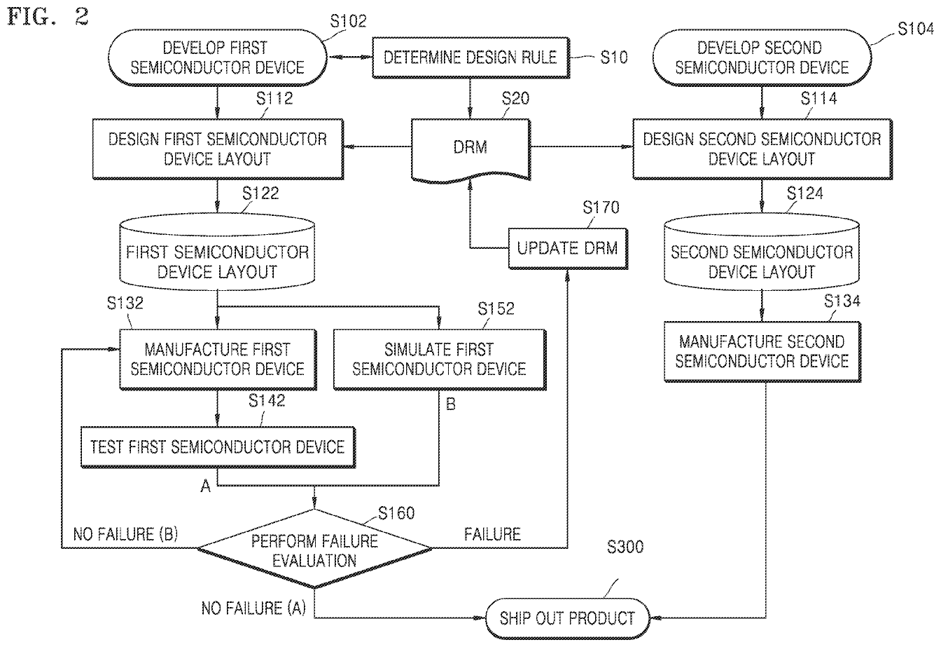

FIG. 2 is a flowchart of a manufacturing method of a semiconductor device, according to an embodiment.

Referring to FIG. 2, after the design rule is determined (S10), a first semiconductor device, to which the design rule is applied, may be developed (S102). The determined design rule may be recorded or stored in the DRM S20. The first semiconductor device layout may be designed based on the DRM S20 (S112). A first semiconductor device may be manufactured using the designed first semiconductor device layout S122 (S132). Thereafter, the manufactured first semiconductor device may be tested (S142). It may then be determined whether a failure has occurred in the first semiconductor device (the failure evaluation may be performed) (S160).

When there is no failure in the first semiconductor device, the completed first semiconductor device may be shipped out as a product (S300). Alternatively, when there is no failure in the first semiconductor device, the first semiconductor device may be mass produced using the designed first semiconductor device layout S122 and shipped out as a product (S300).

In some embodiments, instead of manufacturing the first semiconductor device (S132), a simulation of manufacturing the first semiconductor device using the designed first semiconductor device layout (S122) may be performed (S152). Alternatively, in some embodiments, apart from manufacturing (S132) and testing (S142) of the first semiconductor device, a simulation of manufacturing the first semiconductor device using the designed first semiconductor device layout S122 may be performed altogether (S152). Thereafter, whether a failure has occurred in the first semiconductor device manufactured by the simulation (the failure evaluation) may be performed (S160).

When a failure occurs in the first manufactured semiconductor device and/or when a failure occurs in the first semiconductor device manufactured by simulation, the DRM S20 may be updated (S170).

Thereafter, after the first semiconductor device layout is redesigned or corrected based on the updated DRM S20 (S112), the first semiconductor device may be manufactured (S132), and the manufactured first semiconductor device may be shipped out as a product (S300).

A second semiconductor device may be developed using an updated design rule (S104). After the second semiconductor device layout is designed based on the updated DRM S20 (S114), the second semiconductor device may be manufactured using the designed second semiconductor device layout S124 (S134). Because the second semiconductor device is manufactured based on the updated DRM S20 (S134), a failure may not occur, and thus, the manufactured second semiconductor device may be shipped out as a product (S300).

In the manufacturing method of a semiconductor device according to embodiments of the inventive concept, a similar semiconductor device, for example, the second semiconductor device, may be developed (S104) and manufactured (S134) using the updated DRM S20, and thus, the second semiconductor device having no failure may be developed and manufactured in a short time, and shipped out as a product (S300).

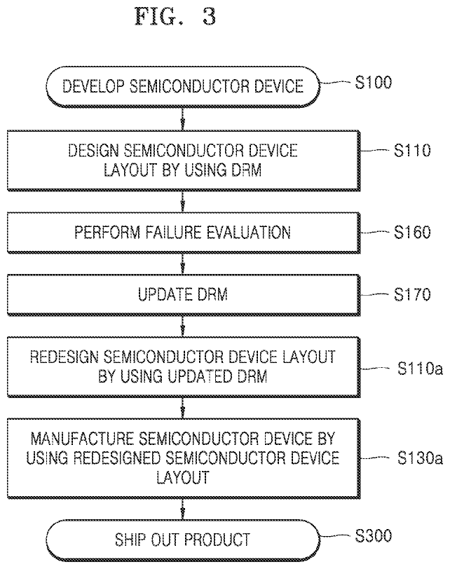

FIG. 3 is a flowchart of a manufacturing method of a semiconductor device, according to an embodiment.

Referring to FIG. 3, after the design rule (S10 in FIGS. 1A and 1B) is determined, a semiconductor device may be developed (S100). A semiconductor device layout may be designed using the DRM (S20 in FIGS. 1A and 1B), in which the determined design rule is recorded (S110). When the failure evaluation (S160) is performed on the semiconductor device manufactured using the designed semiconductor device layout or on the semiconductor device manufactured by simulation, and a failure occurs in the semiconductor device, the DRM S20 may be updated (S170). After the semiconductor device layout is redesigned or corrected using the updated DRM S20 (S110a), the semiconductor device may be manufactured using the re-designed semiconductor device layout (S130a), and shipped out as a product (S300).

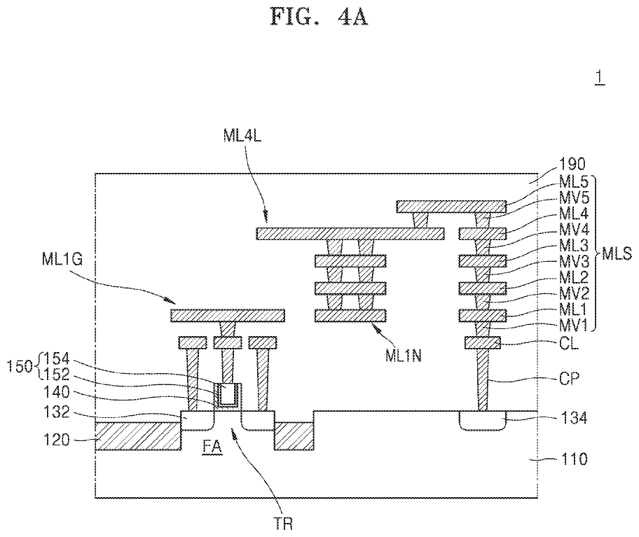

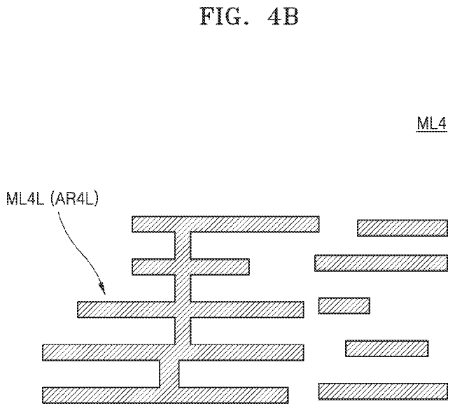

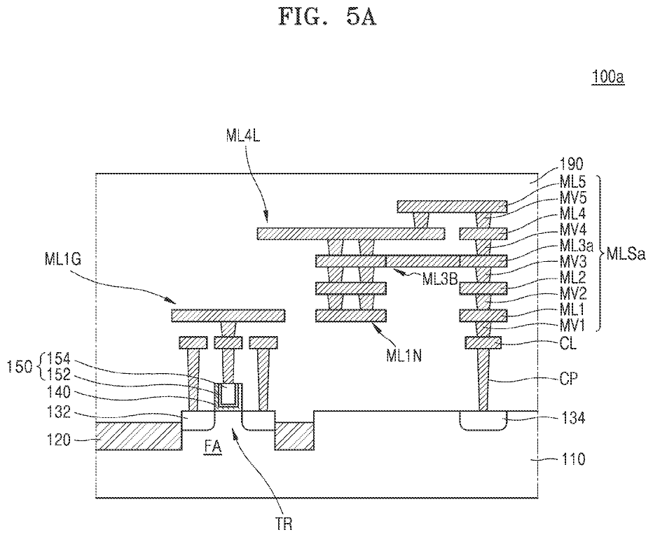

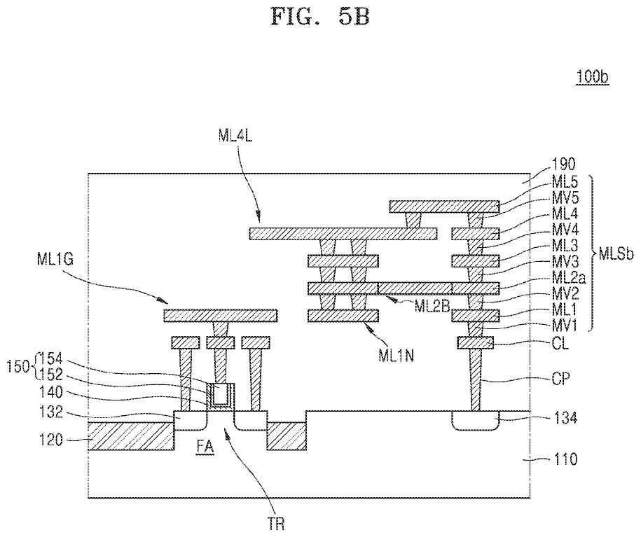

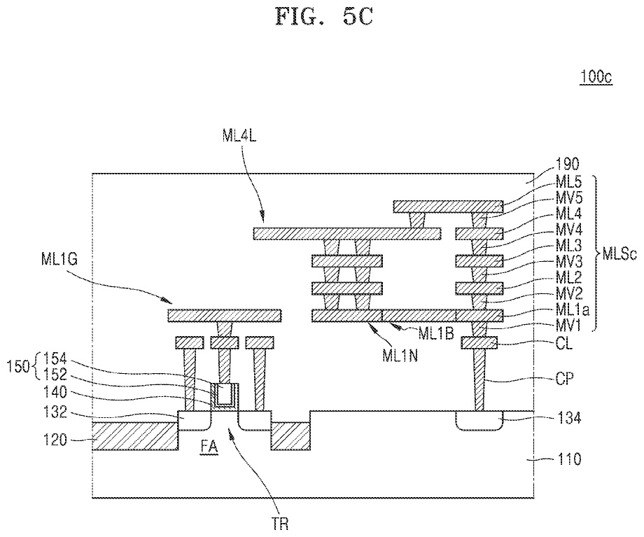

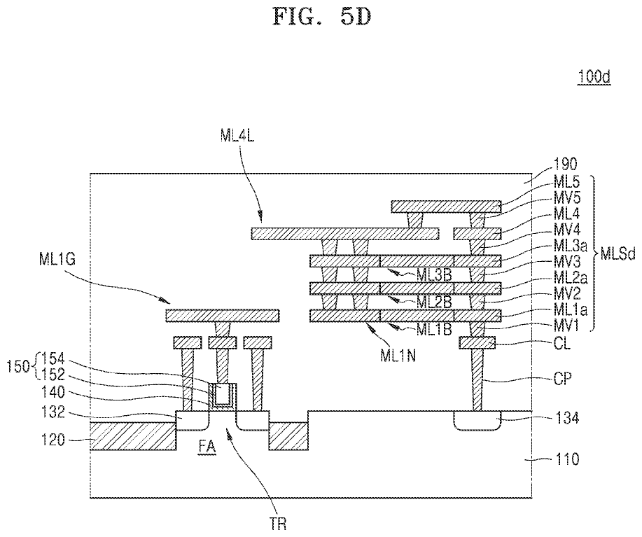

FIGS. 4A, 4B, and 5A through 5D are cross-sectional views of a manufacturing method of a semiconductor device 1, and cross-sectional views of semiconductor devices according to embodiments.

Referring to FIGS. 4A and 4B together, the semiconductor device 1 may include a substrate 110, a transistor TR formed on the substrate 110, a wiring structure MLS arranged on the substrate 110, and an inter-wiring insulating layer 190 surrounding the wiring structure MLS on the substrate 110.

The substrate 110 may include at least one of a Group III-V material and a Group IV material. For example, the substrate 110 may include a semiconductor material, such as Si and Ge, or a compound semiconductor material, such as SiGe, SiC, GaAs, InAs, and InP. The Group III-V material may include a binary, ternary, or quaternary compound including at least one Group III element and at least one Group V element. In some embodiments, when forming an NMOS transistor on a portion of the substrate 110, a portion of the substrate 110 may include any one of the III-V materials exemplified above. In some embodiments, when forming a PMOS transistor on a portion of the substrate 110, at least a portion of the substrate 110 may include Ge. In another example, the substrate 110 may have a semiconductor on insulator (SOI) structure. The substrate 110 may include a conductive region, for example, a well doped with impurities, or a structure doped with impurities.

The substrate 110 may have an active region FA limited by a device isolation layer 120. The device isolation layer 120 may be formed to fill at least a portion of a substrate trench formed by removing a portion of the substrate 110. The device isolation layer 120 may include, for example, an oxide, a nitride, or an oxynitride. In some embodiments, the device isolation layer 120 may include a liner layer covering at least portions of the bottom surface and the lower side of an inner side surface of the substrate trench, and a trench-buried layer covering the liner layer and filling at least a portion of the lower side of the substrate trench. In some embodiments, the liner layer may include an oxide, a nitride, or an oxynitride. For example, the liner layer may include a silicon oxide formed by thermal oxidation, such as silicon nitride (SiN), silicon oxynitride (SiON), silicon boronitride (SiBN), silicon carbide (SiC), SiC:H, silicon carbon nitride (SiCN), SiCN:H, silicon oxy carbon nitride (SiOCN), SiOCN:H, silicon oxy carbide (SiOC), polysilicon, or a combination thereof, but is not limited thereto. The trench-buried layer may include an oxide formed by a deposition process or a coating process. For example, the trench-buried layer may include fluoride silicate glass (FSG), undoped silicate glass (USG), boro-phospho-silicate glass (BPSG), phospho-silicate glass (PSG), flowable oxide (FOX), plasma enhanced tetra-ethyl-ortho-silicate (PE-TEOS), or tonen silazene (TOSZ), but is not limited thereto.

In some embodiments, the active region FA may include a fin-type active region, in which an upper portion thereof protrudes in a fin shape over the device isolation layer 120. When the active region FA is a fin-type active region, the device isolation layer 120 may cover a portion of a lower side of sidewalls of the active region FA.

A first impurity region 132 and a second impurity region 134 arranged apart from each other may be arranged on a portion of the upper side of the substrate 110. For example, the first impurity region 132 may be formed by injecting impurities into portions of the active region FA. The second impurity region 134 may be formed by injecting impurities into a portion of the substrate 110. The first impurity region 132 may be arranged in pairs on portions of the active regions FA arranged apart from each other. For example, a pair of first impurity regions 132 arranged apart from each other at upper portions of the active region FA may include a source/drain region of the transistor TR.

The gate electrode 150 may be arranged on the active region FA. A gate dielectric layer 140 may be arranged between the active region FA and the gate electrode 150. The gate electrode 150 may be arranged on a portion of the active region FA between a pair of first impurity regions 132. For example, in a top view, the pair of first impurity regions 132 may be arranged respectively on both sides of the gate electrode 150. A portion of the active region FA arranged between the pair of first impurity regions 132 may include the channel region.

Each of the gate dielectric layer 140 and the gate electrode 150 may be formed using, for example, an atomic layer deposition (ALD) process, a chemical vapor deposition (CVD) process, a physical vapor deposition (PVD) process, a metal organic (MO) ALD (MOCVD) process, or an MO CVD (MOCVD) process.

In some embodiments, the gate dielectric layer 140 may include a first dielectric layer and a second dielectric layer. The first dielectric layer may conformally cover the surface of the active region FA. The second dielectric layer may cover the first dielectric layer. The second dielectric layer may be arranged between the first dielectric layer and the gate electrode 150.

The second dielectric layer may include a material having a dielectric constant that is greater than a dielectric constant of the material forming the first dielectric layer. In some embodiments, the first dielectric layer may include an interface layer, and the second dielectric layer may include a high-k dielectric layer. For example, the first dielectric layer may include an oxide. In some embodiments, the first dielectric layer may include silicon oxide formed by thermal oxidation. For example, the second dielectric layer may include a material having a greater dielectric constant than silicon oxide. In some embodiments, the second dielectric layer may include a metal oxide or a metal oxynitride. For example, the second dielectric layer may have a dielectric constant of about 10 to about 25. In some embodiments, the second dielectric layer may include at least one of, for example, hafnium oxide (HfO), hafnium silicate (HfSiO), hafnium oxynitride (HfON), hafnium silicon oxynitride (HfSiON), or lanthanum oxide (LaO), lanthanum aluminum oxide (LaAlO), zirconium oxide (ZrO), zirconium silicate (ZrSiO), zirconium oxynitride (ZrON), zirconium silicon oxynitride (ZrSiON), tantalum oxide (TaO), titanium oxide (TiO), barium strontium titanium oxide (BaSrTiO), barium titanium oxide (BaTiO), strontium titanium oxide (SrTiO), yttrium oxide (YO), aluminum oxide (AlO), and lead scandium tantalum oxide (PbScTaO). For example, the second dielectric layer may include HfO₂, Al₂O₃, HfAlO₃, Ta₂O₃, or TiO₂.

The gate electrode 150 may have a structure in which the first electrode layer 152 and a second electrode layer 154 are sequentially stacked. The first electrode layer 152 may include, for example, at least one metal of Ti, Ta, W, Ru, Nb, Mo, and Hf, and the second electrode layer 154 may include, for example, a W layer or an Al layer. In some embodiments, the first electrode layer 152 may include a work function metal-containing layer that may be used to adjust a work function of the transistor TR. The work-function metal-containing layer may include, for example, at least one metal of Ti, W, Ru, Nb, Mo, Hf, Ni, Co, Pt, Yb, Tb, Dy, Er, and Pd. In some embodiments, the gate electrode 150 may have a stacked structure of TiAlC/TiN/W, a stacked structure of TiN/TaN/TiAlC/TiN/W, or a stacked structure of TiN/TaN/TiN/TiAlC/TiN/W, but is not limited thereto.

The active region FA, a pair of first impurity regions 132, the gate dielectric layer 140, and the gate electrode 150 may constitute the transistor TR. Although FIG. 4A illustrates that the transistor TR includes a FinFET, embodiments are not limited thereto. For example, the transistor TR may include a planar transistor. Alternatively, for example, the transistor TR may include a multi-channel transistor including a plurality of nano sheets functioning as a channel region on the active region.

The pair of first impurity regions 132, the second impurity region 134, and the gate electrode 150 may be electrically connected to connection conductive lines CL. Contact plugs CP may be arranged between the pair of first impurity regions 132, the second impurity region 134, and the gate electrode 150. For example, each of the contact plugs CP may be connected to any one of the pair of first impurity regions 132, the second impurity region 134, and the gate electrode 150, and the connection conductive lines CL may be respectively connected to the contact plugs CP. Each of the connection conductive lines CL may be electrically connected to a first wiring pattern ML1 via a first wiring via MV1.

The wiring structure MLS may include a plurality of wiring patterns arranged at different vertical levels. Each of the plurality of wiring patterns may have, for example, a polygonal shape, such as a line shape, a bar shape, or a square shape in a plan view. For example, each of the plurality of wiring patterns may include the first wiring pattern ML1, a second wiring pattern ML2, a third wiring pattern ML3, a fourth wiring pattern ML4, and a fifth wiring pattern MLS, which are arranged at different vertical levels from each other. Although FIGS. 4A through 8 illustrate that the wiring structure MLS includes a plurality of wiring patterns at five different vertical levels, embodiments are not limited thereto. For example, the wiring structure MLS may include a plurality of wiring patterns at two or more different vertical levels.

Although in FIGS. 4A through 8 the fifth wiring pattern ML5 is illustrated as being arranged at the highest vertical level among the first wiring pattern ML1, the second wiring pattern ML2, the third wiring pattern ML3, the fourth wiring pattern ML4, and the fifth wiring pattern ML5, embodiments are not limited thereto. According to embodiments, because the fifth wiring pattern ML5 is at a relatively upper side, other wiring patterns may be further arranged on the fifth wiring pattern ML5. Similarly, although in FIGS. 4A through 8 the first wiring pattern ML1 is illustrated as being arranged at the lowest vertical level among the first wiring pattern ML1, the second wiring pattern ML2, the third wiring pattern ML3, the fourth wiring pattern ML4, and the fifth wiring pattern ML5, embodiments are not limited thereto. According to embodiments, because the first wiring pattern ML1 is arranged at a relatively lower side, other wiring patterns may be further arranged under the first wiring pattern ML1.

The wiring structure MLS may include a plurality of wiring vias arranged at different vertical levels from each other. Each of the plurality of wiring vias may have a pillar shape extending in a vertical direction. In some embodiments, each of the plurality of wiring vias may have a tapered shape extending from an upper side thereof to a lower side thereof with a narrowing horizontal width. For example, the plurality of wiring vias may include the first wiring via MV1, a second wiring via MV2, a third wiring via MV3, a fourth wiring via MV4, and a fifth wiring via MV5. The first wiring via MV1 may be connected to a lower surface of the first wiring pattern ML1, and electrically connected between the first wiring pattern ML1 and the components under the first wiring pattern ML1. For example, the first wiring via MV1 may be electrically connected between the first wiring pattern ML1 and the connection conductive line CL. The second wiring via MV2 may be connected to a lower surface of the second wiring pattern ML2, and electrically connected between the second wiring pattern ML2 and the components under the second wiring pattern ML2. For example, the second wiring via MV2 may be electrically connected between the second wiring pattern ML2 and the first wiring pattern ML1. The third wiring via MV2 may be connected to a lower surface of the third wiring pattern ML3, and electrically connected between the third wiring pattern ML3 and the components under the third wiring pattern ML3. For example, the third wiring via MV3 may be electrically connected between the third wiring pattern ML3 and the second wiring pattern ML2. The fourth wiring via MV4 may be connected to a lower surface of the fourth wiring pattern ML4, and electrically connected between the fourth wiring pattern ML4 and the components under the fourth wiring pattern ML4. For example, the fourth wiring via MV4 may be electrically connected between the fourth wiring pattern ML4 and the third wiring pattern ML3. The fifth wiring via MV5 may be connected to a lower surface of the fifth wiring pattern ML5, and electrically connected between the fifth wiring pattern ML5 and the components under the fifth wiring pattern ML5. For example, the fifth wiring via MV5 may be electrically connected between the fifth wiring pattern ML5 and the fourth wiring pattern ML4.

Each of the first wiring pattern ML1, the second wiring pattern ML2, the third wiring pattern ML3, the fourth wiring pattern ML4, and the fifth wiring pattern ML5, and each of the first wiring via MV1, the second wiring via MV2, the third wiring via MV3, the fourth wiring via MV4, and the fifth wiring via M5, may be provided in plural.

The inter-wiring insulating layer 190 may surround the wiring structure MLS on the substrate 110. In some embodiments, the inter-wiring insulating layer 190 may surround the gate electrode 150, the connection conductive lines CL, and the contact plugs CP, together with the wiring structure MLS on the substrate 110. For example, the inter-wiring insulating layer 190 may include a plurality of stacked insulating layers. The inter-wiring insulating layer 190 may include an insulating material having a lower dielectric constant than, for example, silicon oxide, silicon nitride, silicon oxynitride, or silicon oxide. In some embodiments, at least a portion of the inter-wiring insulating layer 190 may include an ultra low k (ULK) layer having an ultra low dielectric constant k of about 2.2 to about 2.4. The ULK layer may include a SiOC layer or a SiCOH layer.

A wiring pattern arranged at a relatively upper side, for example, the fifth wiring pattern ML5, may be electrically connected to the substrate 110 via the fifth wiring via MV5, the fourth wiring pattern ML4, the fourth wiring via MV4, the third wiring pattern ML3, the third wiring via ML3, the second wiring pattern ML2, the second wiring via ML2, the first wiring pattern ML1, the first wiring via MV1, the connection conductive line CL, the contact plug CP, and the second impurity region 134. For example, the second impurity region 134 may reduce the contact resistance between the contact plug CP and the substrate 110. Each of the fifth wiring via MV5, the fourth wiring pattern ML4, the fourth wiring via MV4, the third wiring pattern ML3, the third wiring via MV3, the second wiring pattern ML2, the second wiring via MV2, the first wiring pattern ML1, and the first wiring via MV1, which are arranged between the fifth wiring pattern ML5 and the second impurity region 134 and electrically connect the fifth wiring pattern ML5 to the second impurity region 134, may be called a fifth connection wiring via, a fourth connection wiring pattern, a fourth connection wiring via, a third connection wiring pattern, a third connection wiring via, a second connection wiring pattern, a second connection wiring via, a first connection wiring pattern, and a first connection wiring via, respectively.

In FIGS. 4A through 8, it is illustrated that the fifth wiring pattern ML5 may be electrically connected to the substrate 110 via the fifth wiring via MV5, the fourth wiring pattern ML4, the fourth wiring via MV4, the third wiring pattern ML3, the third wiring via MV3, the second wiring pattern ML2, the second wiring via MV2, the first wiring pattern ML1, the first wiring via MV1, the connection conductive line CL, the contact plug CP, and the second impurity region 134, in sequence, but embodiments are not limited thereto. For example, in some embodiments, the fifth wiring pattern ML5 may be electrically connected to the substrate 110 via the fifth wiring via MV5, the fourth wiring pattern ML4, the fourth wiring via MV4, the third wiring pattern ML3, the third wiring via MV3, the second wiring pattern ML2, the second wiring via MV2, the first wiring pattern ML1, the first wiring via MV1, the connection conductive line CL, at least one of the contact plugs CP, and the second impurity region 134. In some embodiments, the fifth wiring via MV5 may also be connected between the bottom surface of the fifth wiring pattern ML5 and the second impurity region 134.

A wiring pattern arranged relatively at an upper side, for example, the fifth wiring pattern ML5, may be electrically connected to any one of other wiring patterns, which are not electrically connected to the substrate 110 without using the fifth wiring pattern ML5, for example, the fourth wiring pattern ML4, the third wiring pattern ML3, the second wiring pattern ML2, and the first wiring pattern ML1, which are not electrically connected to the substrate 110. At least one of other wiring patterns, which are not electrically connected to the substrate 110 without using the fifth wiring pattern ML5, for example, the fourth wiring pattern ML4, the third wiring pattern ML3, the second wiring pattern ML2, and the first wiring pattern ML1, may be electrically floated from the substrate 110 before the fifth wiring pattern ML5 is formed.

At least one of a plurality of first wiring patterns ML1 may include a gate wiring pattern ML1G electrically connected to the gate electrode 150. At least one of the plurality of first wiring patterns ML1 may be adjacent to the gate wiring pattern ML1G, but may include a first adjacent wiring pattern ML1N, which is electrically connected to the substrate 110 only via the fifth wiring pattern ML5, which is floated from the substrate 110 before the fifth wiring pattern ML5 is formed. At least one of the plurality of wiring patterns, for example, at least one of a plurality of fourth wiring patterns ML4, may include a target wiring pattern ML4L, which is electrically connected to the substrate 110 only via the fifth wiring pattern ML5, which is electrically floated from the substrate 110 before the fifth wiring pattern ML5 is formed and has a relatively large area. The target wiring pattern ML4L may have an area AR4L, which is relatively larger than areas of object wiring patterns at an identical vertical level thereto, for example, the fourth wiring patterns ML4. The target wiring pattern ML4L may refer to the fourth wiring patterns ML4 connected to each other at an identical vertical level. In other words, the area AR4L of the relatively large target wiring pattern ML4L may mean a total area of the fourth wiring patterns ML4 connected to each other at the identical vertical level. The area AR4L of the target wiring pattern ML4L may be hundreds μm² to thousands μm². In some embodiments, the maximum area of the target wiring pattern ML4L may be about 300 μm².

The target wiring pattern ML4L may be electrically connected to the first adjacent wiring pattern ML1N. For example, the target wiring pattern ML4L may be electrically connected to the first adjacent wiring pattern ML1N via the fourth wiring via MV4, the third wiring pattern ML3, the third wiring via MV3, the second wiring pattern ML2, and the second wiring via MV2. The target wiring pattern ML4L and the first adjacent wiring pattern ML1N may be electrically floated from the substrate 110 before the fifth wiring pattern ML5 is formed. The fourth wiring via MV4, the third wiring pattern ML3, the third wiring via MV3, the second wiring pattern ML2, and the second wiring via MV2, which are arranged between the target wiring pattern ML4L and the first adjacent wiring pattern ML1N, and electrically connect the target wiring pattern ML4L to the first adjacent wiring pattern ML1N, may be referred to as a fourth adjacent wiring via, a third adjacent wiring pattern, a third adjacent wiring via, a second adjacent wiring pattern, and a second adjacent wiring via, respectively.

At the same vertical level, the first adjacent wiring pattern ML1N and the first connection wiring pattern may be arranged apart from each other. At the same vertical level, the second adjacent wiring pattern ML2N and the second connection wiring pattern may be arranged apart from each other. At the same vertical level, the third adjacent wiring pattern ML3N and the third connection wiring pattern may be arranged apart from each other. At the same vertical level, the target wiring pattern ML4L and the fourth connection wiring pattern may be arranged apart from each other.

The semiconductor device 1 illustrated in FIGS. 4A and 4B may include a semiconductor device manufactured (see S130) using the semiconductor device layout S120 designed based on the DRM S20 described with reference to FIGS. 1A through 1D, or a semiconductor device S150 manufactured using simulation on the designed semiconductor device layout S120. The area AR4L of the target wiring pattern ML4L may be an area satisfying the design rule recorded in the DRM S20.

Referring to FIG. 5A, a semiconductor device 100a may include the substrate 110, the transistor TR formed on the substrate 110, a wiring structure MLSa arranged on the substrate 110, and the inter-wiring insulating layer 190 surrounding the wiring structure MLSa on the substrate 110.

The wiring structure MLSa may include a plurality of wiring patterns arranged at different vertical levels from each other. For example, each of the plurality of wiring patterns may include the first wiring pattern ML1, the second wiring pattern ML2, a third wiring pattern ML3a, the fourth wiring pattern ML4, and the fifth wiring pattern ML5, which are arranged at different vertical levels from each other. The wiring structure MLSa may include a plurality of wiring vias arranged at different vertical levels from each other. For example, the plurality of wiring vias may include the first wiring via MV1, the second wiring via MV2, the third wiring via MV3, the fourth wiring via MV4, and the fifth wiring via MV5.

Compared to the third wiring pattern ML3 included in the wiring structure MLS included in the semiconductor device 1 illustrated in FIGS. 4A and 4B, the third wiring pattern ML3a included in the wiring structure MLSa included in the semiconductor device 100a illustrated in FIG. 5A may further include a bridge wiring pattern ML3B. In FIG. 5A, the bridge wiring pattern ML3B is illustrated as being included in the third wiring pattern ML3, but embodiments are not limited thereto. For example, according to embodiments, the bridge wiring pattern ML3B may be included in a wiring pattern arranged at a lower vertical level than the target wiring pattern ML4L.

The target wiring pattern ML4L may be electrically connected to the substrate 110 via the bridge wiring pattern ML3B. For example, the target wiring pattern ML4L may be electrically connected to the substrate 110 by sequentially passing through the fourth wiring via MV4, the third wiring pattern ML3a including the bridge wiring pattern ML3B, the third wiring via MV3, the second wiring pattern ML2, the second wiring via MV2, the first wiring pattern ML1, the first wiring via MV1, the connection conductive line CL, the contact plug CP, and the second impurity region 134. The target wiring pattern ML4L may be electrically connected to the substrate 110 via the bridge wiring pattern ML3B without passing through a wiring pattern arranged at a relatively upper side, for example, the fifth wiring pattern ML5. Thus, in embodiments, the target wiring pattern ML4L is not electrically floated from the substrate 110 even before the fifth wiring pattern ML5 is formed, but may be electrically connected to the substrate 110 via the bridge wiring pattern ML3B.

Referring to FIG. 5B, a semiconductor device 100b may include the substrate 110, the transistor TR formed in a portion of the substrate 110 and on the substrate 110, a wiring structure MLSb arranged on the substrate 110, and the inter-wiring insulating layer 190 surrounding the wiring structure MLSb on the substrate 110.

The wiring structure MLSb may include a plurality of wiring patterns arranged at different vertical levels from each other. For example, each of the plurality of wiring patterns may include the first wiring pattern ML1, a second wiring pattern ML2a, the third wiring pattern ML3, the fourth wiring pattern ML4, and the fifth wiring pattern ML5, which are arranged at different vertical levels from each other. The wiring structure MLSb may include a plurality of wiring vias arranged at different vertical levels from each other. For example, the plurality of wiring vias may include the first wiring via MV1, the second wiring via MV2, the third wiring via MV3, the fourth wiring via MV4, and the fifth wiring via MV5.

Compared to the second wiring pattern ML2 included in the wiring structure MLS included in the semiconductor device 1 illustrated in FIGS. 4A and 4B, the second wiring pattern ML2a included in the wiring structure MLSb included in the semiconductor device 100b illustrated in FIG. 5B may further include a bridge wiring pattern ML2B.

The target wiring pattern ML4L may be electrically connected to the substrate 110 via the bridge wiring pattern ML2B. For example, the target wiring pattern ML4L may be electrically connected to the substrate 110 by sequentially passing through the fourth wiring via MV4, the third wiring pattern ML3, the third wiring via MV3, the second wiring pattern ML2a including the bridge wiring pattern ML2B, the second wiring via MV2, the first wiring pattern ML1, the first wiring via MV1, the connection conductive line CL, the contact plug CP, and the second impurity region 134. The target wiring pattern ML4L may be electrically connected to the substrate 110 via the bridge wiring pattern ML2B without passing through a wiring pattern arranged at a relatively upper side, for example, the fifth wiring pattern ML5. Thus, in embodiments, the target wiring pattern ML4L is not electrically floated from the substrate 110 even before the fifth wiring pattern ML5 is formed, but may be electrically connected to the substrate 110 via the bridge wiring pattern ML2B.

Referring to FIG. 5C, a semiconductor device 100c may include the substrate 110, the transistor TR formed in a portion of the substrate 110 and on the substrate 110, a wiring structure MLSc arranged on the substrate 110, and the inter-wiring insulating layer 190 surrounding the wiring structure MLSc on the substrate 110.

The wiring structure MLSc may include a plurality of wiring patterns arranged at different vertical levels from each other. For example, each of the plurality of wiring patterns may include a first wiring pattern ML1a, the second wiring pattern ML2, the third wiring pattern ML3, the fourth wiring pattern ML4, and the fifth wiring pattern ML5, which are arranged at different vertical levels from each other. A wiring structure MLSc may include a plurality of wiring vias arranged at different vertical levels from each other. For example, the plurality of wiring vias may include the first wiring via MV1, the second wiring via MV2, the third wiring via MV3, the fourth wiring via MV4, and the fifth wiring via MV5.

Compared to the first wiring pattern ML1 included in the wiring structure MLS included in the semiconductor device 1 illustrated in FIGS. 4A and 4B, the first wiring pattern ML1a included in the wiring structure MLSc included in the semiconductor device 100c illustrated in FIG. 5C may further include a bridge wiring pattern ML1B.

The target wiring pattern ML4L may be electrically connected to the substrate 110 via the bridge wiring pattern ML1B. For example, the target wiring pattern ML4L may be electrically connected to the substrate 110 by sequentially passing through the fourth wiring via MV4, the third wiring pattern ML3, the third wiring via MV3, the second wiring pattern ML2, the second wiring via MV2, the first wiring pattern ML1a including the bridge wiring pattern ML1B, the first wiring via MV1, the connection conductive line CL, the contact plug CP, and the second impurity region 134. The target wiring pattern ML4L may be electrically connected to the substrate 110 via a bridge wiring pattern ML1B without passing through a wiring pattern arranged at a relatively upper side, for example, the fifth wiring pattern ML5. Thus, in embodiments, the target wiring pattern ML4L is not electrically floated from the substrate 110 even before the fifth wiring pattern ML5 is formed, but may be electrically connected to the substrate 110 via the bridge wiring pattern ML1B.

Referring to FIG. 5D, a semiconductor device 100d may include the substrate 110, the transistor TR formed in a portion of the substrate 110 and on the substrate 110, a wiring structure MLSd arranged on the substrate 110, and the inter-wiring insulating layer 190 surrounding the wiring structure MLSd on the substrate 110.

The wiring structure MLSd may include a plurality of wiring patterns arranged at different vertical levels from each other. For example, each of the plurality of wiring patterns may include a first wiring pattern ML1a, the second wiring pattern ML2a, the third wiring pattern ML3a, the fourth wiring pattern ML4, and the fifth wiring pattern ML5, which are arranged at different vertical levels from each other. The wiring structure MLSd may include a plurality of wiring vias arranged at different vertical levels from each other. For example, the plurality of wiring vias may include the first wiring via MV1, the second wiring via MV2, the third wiring via MV3, the fourth wiring via MV4, and the fifth wiring via MV5.

Compared to the first wiring pattern ML1, the second wiring pattern ML2, and the third wiring pattern ML3 included in the wiring structure MLS included in the semiconductor device 1 illustrated in FIGS. 4A and 4B, the first wiring pattern ML1a, the second wiring pattern ML2a, and the third wiring pattern ML3a included in the wiring structure MLSd included in the semiconductor device 100d illustrated in FIG. 5D may further include bridge wiring patterns ML1B, ML2B, and ML3B. The bridge wiring pattern ML1B included in the first wiring pattern ML1a may be referred to as a first bridge wiring pattern, the bridge wiring pattern ML2B included in the second wiring pattern ML2a may be referred to as a second bridge wiring pattern, and the bridge wiring pattern ML3B included in the third wiring pattern ML3a may be referred to as a third bridge wiring pattern.

The target wiring pattern ML4L may be electrically connected to the substrate 110 via the bridge wiring patterns ML1B, ML2B, and ML3B. The target wiring pattern ML4L may be electrically connected to the substrate 110 via the bridge wiring patterns ML1B, ML2B, and ML3B without passing through a wiring pattern arranged at a relatively upper side, for example, the fifth wiring pattern ML5. Thus, in embodiments, the target wiring pattern ML4L is not electrically floated from the substrate 110 even before the fifth wiring pattern ML5 is formed, but may be electrically connected to the substrate 110 via the bridge wiring patterns ML1B, ML2B, and ML3B.

The semiconductor devices 100a, 100b, 100c, and 100d illustrated in FIGS. 5A through 5D may include the semiconductor device S130 manufactured using the semiconductor device layout S120 designed based on the updated DRM S20 described with reference to FIGS. 1A through 1D. When the target wiring pattern ML4L having a relatively large area AR4L is present, for example, an area larger than the threshold maximum area, a design rule for adding the bridge wiring patterns ML1B, ML2B, and ML3B connecting wiring patterns arranged at lower vertical levels than the target wiring pattern ML4L may be recorded.

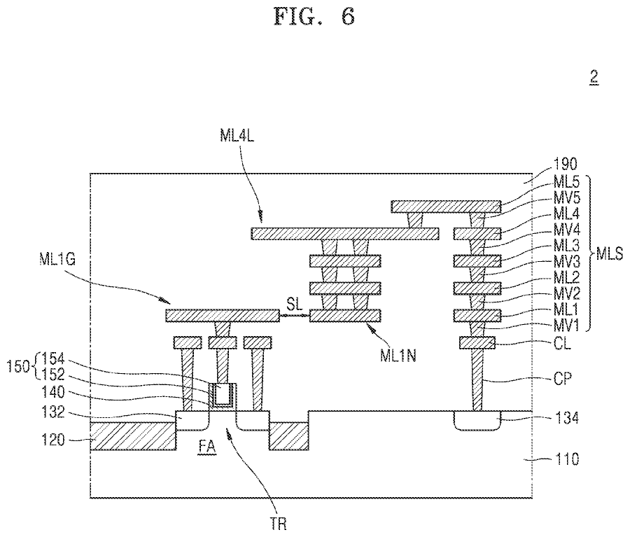

FIGS. 6, 7, and 8 are cross-sectional views of a manufacturing method of semiconductor devices, and cross-sectional views of semiconductor devices, according to embodiments.

Referring to FIG. 6, a semiconductor device 2 may include the substrate 110, the transistor TR formed in a portion of the substrate 110 and on the substrate 110, the wiring structure MLS arranged on the substrate 110, and the inter-wiring insulating layer 190 surrounding the wiring structure MLS on the substrate 110. The semiconductor device 2 may be generally the same as the semiconductor device 1 illustrated in FIGS. 4A and 4B. For convenience of explanation, components having identical reference numbers are identical components, and thus, duplicate descriptions thereof are omitted.

At least one of a plurality of first wiring patterns ML1 may include the gate wiring pattern ML1G electrically connected to the gate electrode 150. At least one of the plurality of first wiring patterns ML1 may be adjacent to the gate wiring pattern ML1G, but may include a first adjacent wiring pattern ML1N, which is electrically connected to the substrate 110 only via the fifth wiring pattern ML5, which is floated from the substrate 110 before the fifth wiring pattern ML5 is formed. The gate wiring pattern ML1G and the first adjacent wiring pattern ML1N have a first separation interval SL, and may be arranged apart from each other in a horizontal direction. The first separation interval SL may be several nm to several tens of nm.

The semiconductor device 2 illustrated in FIG. 6 may be the semiconductor device manufactured (S130) using the semiconductor device layout S120 designed based on the DRM S20 described with reference to FIGS. 1A through 1D, or the semiconductor device manufactured using simulation (S150) on the designed semiconductor device layout S120. The first separation interval SL between the gate wiring pattern ML1G and the first adjacent wiring pattern ML1N may have an area satisfying the design rule recorded in the DRM S20.

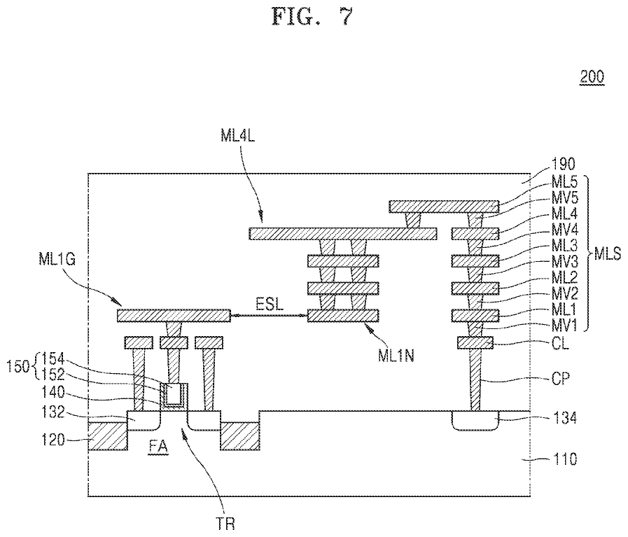

Referring to FIG. 7, a semiconductor device 200 may include the substrate 110, the transistor TR formed in a portion of the substrate 110 and on the substrate 110, the wiring structure MLS arranged on the substrate 110, and the inter-wiring insulating layer 190 surrounding the wiring structure MLS on the substrate 110.

Compared to the semiconductor device 2 illustrated in FIG. 6, the gate wiring pattern ML1G and the first adjacent wiring pattern ML1N included in the semiconductor device 200 illustrated in FIG. 7 may have a second separation interval ESL, and may be arranged apart from each other in a horizontal direction. The second separation interval ESL may be greater than the first separation interval SL. The second separation interval ESL may be greater than the first separation interval SL by several nm to several tens of nm.

The semiconductor device 200 illustrated in FIG. 7 may include the semiconductor device manufactured (S130) using the semiconductor device layout S120 designed based on the updated DRM S20 described with reference to FIGS. 1A through 1D. In the updated DRM S20, a design rule may be recorded, in which the first adjacent wiring pattern ML1N, which is adjacent to the gate wiring pattern ML1G but is electrically floated from the substrate 110 before the fifth wiring pattern ML5 is formed, has a minimum separation interval greater than the minimum separation interval between the other first wiring patterns ML1.

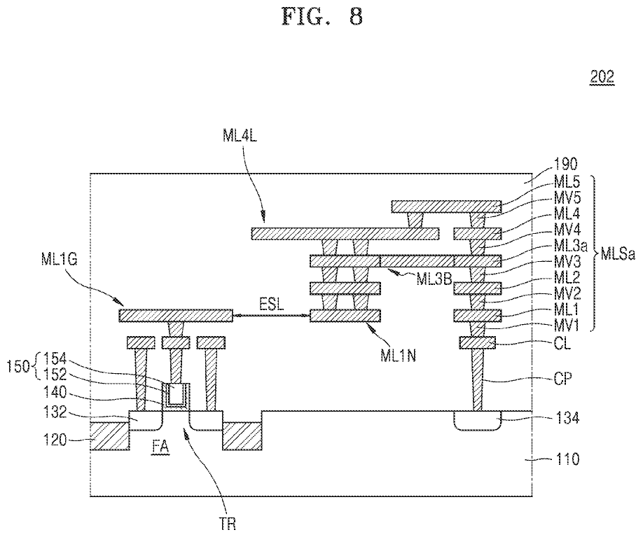

Referring to FIG. 8, a semiconductor device 202 may include the substrate 110, the transistor TR formed in a portion of the substrate 110 and on the substrate 110, the wiring structure MLS arranged on the substrate 110, and the inter-wiring insulating layer 190 surrounding the wiring structure MLSa on the substrate 110.

Compared to the semiconductor device 2 illustrated in FIG. 6, the gate wiring pattern ML1G and the first adjacent wiring pattern ML1N included in the semiconductor device 202 illustrated in FIG. 8 may have the second separation interval ESL, and may be arranged apart from each other in a horizontal direction. The second separation interval ESL may be greater than the first separation interval SL.

Compared to the third wiring pattern ML3 included in the wiring structure MLS included in the semiconductor device 2 illustrated in FIG. 6, the third wiring pattern ML3a included in the wiring structure MLSa included in the semiconductor device 202 illustrated in FIG. 8 may further include the bridge wiring pattern ML3B. In FIG. 8, the bridge wiring pattern ML3B is illustrated as being included in the third wiring pattern ML3, but embodiments are not limited thereto. For example, the semiconductor device 202 illustrated in FIG. 8 may include the bridge wiring pattern ML2B as a semiconductor device 1b illustrated in FIG. 5B, or the bridge wiring pattern ML1B as a semiconductor device 1c illustrated in FIG. 5C, or the bridge wiring patterns ML1B, ML2B, and MLB3 as the semiconductor device 1d illustrated in FIG. 5D.

The semiconductor device 202 illustrated in FIG. 8 may include the semiconductor device manufactured (S130) using the semiconductor device layout S120 designed based on the updated DRM S20 described with reference to FIGS. 1A through 1D. In the updated DRM S20, a design rule may be recorded, in which the first adjacent wiring pattern ML1N, which is adjacent to the gate wiring pattern ML1G but is electrically floated from the substrate 110 before the fifth wiring pattern ML5 is formed, has a minimum separation interval greater than the minimum separation interval between the other first wiring patterns ML1, and a design rule may be recorded, in which, when there is the target wiring pattern ML4L having a relatively large area AR4L, the bridge wiring patterns ML1B, ML2B, and ML3B are formed.

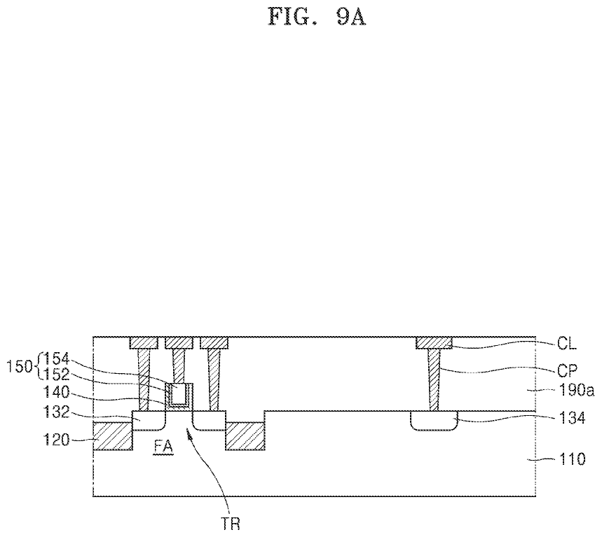

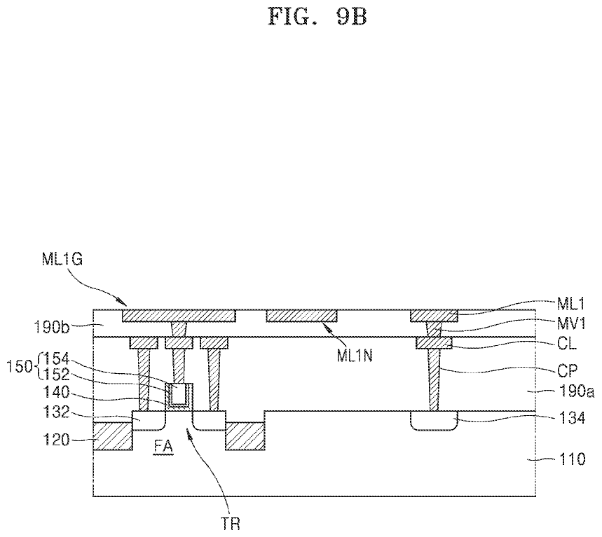

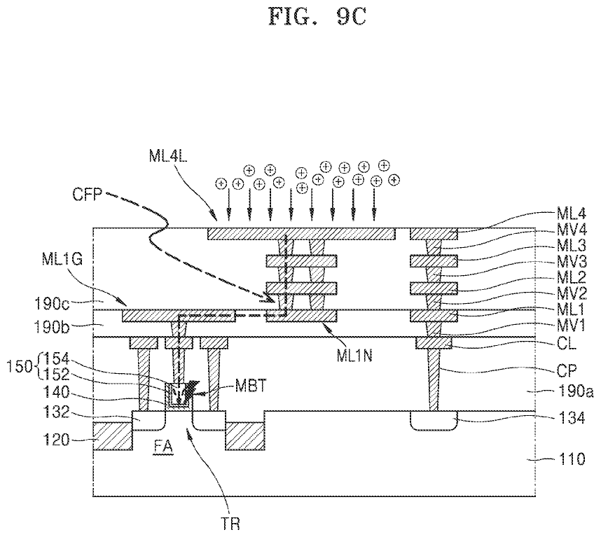

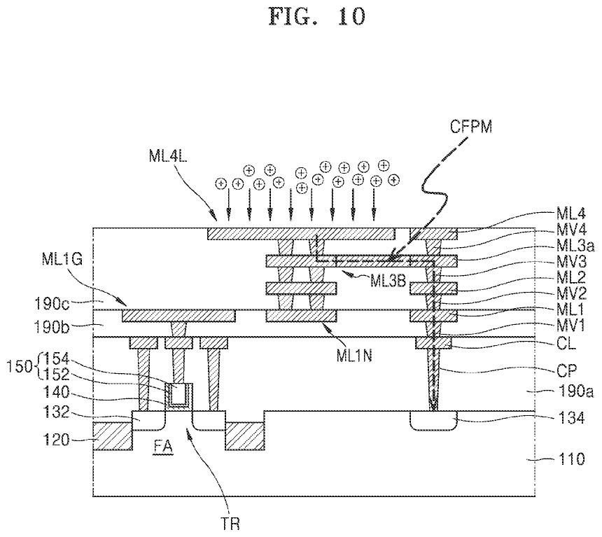

FIGS. 9A through 9C and 10 are cross-sectional views of a manufacturing method of a semiconductor device, according to embodiments. FIGS. 9A through 9C and 10 are cross-sectional views for describing a process of manufacturing the semiconductor device 100a illustrated in FIG. 5A using the updated DRM S20 after the failure evaluation of the semiconductor device 1 illustrated in FIGS. 4A and 4B is performed (S160), with reference to FIGS. 1 through 3.

Referring to FIGS. 1A through 5A and 9A together, after a substrate trench is formed in the substrate 110, the device isolation layer 120 filling at least a portion of the substrate trench may be formed. A portion of the substrate 110 defined by the device isolation layer 120 may include an active region FA. In some embodiments, the active region FA may be formed as a fin-type active region, in which an upper portion thereof protrudes in a fin shape over the device isolation layer 120.

The first impurity region 132 and the second impurity region 134 may be formed on a portion of the upper side of the substrate 110. For example, the first impurity region 132 may be formed by injecting impurities into portions of the active region FA. The second impurity region 134 may be formed by injecting impurities into a portion of the substrate 110. The first impurity region 132 may be formed in pairs on portions of the active regions FA arranged apart from each other.

The gate electrode 150 may be formed on the active region FA. The gate dielectric layer 140 may be formed to be arranged between the active region FA and the gate electrode 150. For example, the gate dielectric layer 140 and the gate electrode 150 may be sequentially formed on the active region FA.

On the substrate 110, the pair of first impurity regions 132, the second impurity region 134, the contact plugs CP connected to the gate electrode 150, and the connection conductive lines CL connected to the contact plugs CP may be formed. The connection conductive lines CL may be formed to be electrically connected to the pair of first impurity regions 132, the second impurity region 134, and the gate electrode 150 via the contact plugs CP.

On the substrate 110, the gate electrode 150, the connection conductive lines CL, and a first preliminary inter-wiring insulating layer 190a surrounding the contact plugs CP may be formed. The first preliminary inter-wiring insulating layer 190a may include a lower portion of the inter-wiring insulating layer 190 illustrated in FIG. 4A. For example, the first preliminary inter-wiring insulating layer 190a may include a portion of the inter-wiring insulating layer 190 illustrated in FIG. 4A, which surrounds the gate electrode 150, the connection conductive lines CL, and the contact plugs CP.

Referring to FIGS. 1A through 5A and 9B together, a plurality of first wiring vias MV1 and a plurality of first wiring patterns ML1 may be formed on the connection conductive lines CL. At least some of the plurality of first wiring patterns ML1 may be connected to at least one of the plurality of first wiring vias MV1 thereunder.

At least one of the plurality of first wiring patterns ML1 may be the gate wiring pattern ML1G electrically connected to the gate electrode 150 via at least one of the first wiring vias MV1. At least one of the plurality of first wiring patterns ML1 may be adjacent to the gate wiring pattern ML1G, and may include the first adjacent wiring pattern ML1N electrically floated from the substrate 110.

On the first preliminary inter-wiring insulating layer 190a, a second preliminary inter-wiring insulating layer 190b surrounding the plurality of first wiring vias MV1 and the plurality of first wiring patterns ML1 may be formed. The second preliminary inter-wiring insulating layer 190b may include a portion of the inter-wiring insulating layer 190 illustrated in FIG. 4A. For example, the second preliminary inter-wiring insulating layer 190b may include a portion of the inter-wiring insulating layer 190 illustrated in FIG. 4A surrounding the plurality of first wiring vias MV1 and the plurality of first wiring patterns ML1.

Referring to FIGS. 1A through 5A and 9C together, a plurality of wiring vias and a plurality of wiring patterns may be formed on a plurality of second wiring patterns ML2. For example, on the plurality of second wiring patterns ML2, a plurality of second wiring vias MV2, the plurality of second wiring patterns ML2, a plurality of third wiring vias MV3, a plurality of third wiring patterns ML3, a plurality of fourth wiring vias MV4, and a plurality of fourth wiring patterns ML4 may be formed sequentially.

On the second preliminary inter-wiring insulating layer 190b, a third preliminary inter-wiring insulating layer 190c surrounding the plurality of second wiring vias MV2, the plurality of second wiring patterns ML2, the plurality of third wiring vias MV3, the plurality of third wiring patterns ML3, the plurality of fourth wiring vias MV4, and the plurality of fourth wiring patterns ML4 may be formed. The first preliminary inter-wiring insulating layer 190a may include a portion of the inter-wiring insulating layer 190 illustrated in FIG. 4A. For example, the third preliminary inter-wiring insulating layer 190c may include a portion of the inter-wiring insulating layer 190 illustrated in FIG. 4A surrounding the plurality of second wiring vias MV2, the plurality of second wiring patterns ML2, the plurality of third wiring vias MV3, the plurality of third wiring patterns ML3, the plurality of fourth wiring vias MV4, and the plurality of fourth wiring patterns ML4.

At least one of the plurality of wiring patterns, for example, at least one of the plurality of fourth wiring patterns ML4, may be a target wiring pattern ML4L that is electrically floated from the substrate 110 and has a relatively large area. The target wiring pattern ML4L may have the area (AR4L in FIG. 4B) that is relatively larger than areas of object wiring patterns at an identical vertical level thereto, for example, the fourth wiring patterns ML4.

During the process of forming the third preliminary inter-wiring insulating layer 190c, charges may be charged in the target wiring pattern ML4L. For example, the target wiring pattern ML4L may be charged by plasma used in the process of forming the third preliminary inter-wiring insulating layer 190c. The first adjacent wiring pattern ML1N and the first adjacent wiring pattern ML1N electrically connected to the target wiring pattern ML4L may be floated from the substrate 110. Accordingly, in the process of forming the third preliminary inter-wiring insulating layer 190c, charges charged in the target wiring pattern ML4L may move to the first adjacent wiring pattern ML1N and also charge the first adjacent wiring pattern ML1N. When a separation interval between the first adjacent wiring pattern ML1N and the gate wiring pattern ML1G is not sufficiently large, the charges charged in the first adjacent wiring pattern ML1N may cause a coupling effect in the gate wiring pattern ML1G, and a charge flow path CFP may be generated from the target wiring pattern ML4L to the gate electrode 150, the gate dielectric layer 140, or a channel region, that is, the active region FA. In this case, a break in the gate dielectric layer 140, a burn in the channel region, that is, an active region FA, or a burn in the gate electrode 150 may occur, and failures may occur in the semiconductor device 1 illustrated in FIGS. 4A and 4B.

Referring to FIGS. 1A through 5A and 10 together, instead of the third wiring pattern ML3 illustrated in FIG. 9C, the third wiring pattern ML3a including the bridge wiring pattern ML3B may be formed like the semiconductor device 100a illustrated in FIG. 5A.

In the process of forming the third preliminary inter-wiring insulating layer 190c, when the target wiring pattern ML4L is charged with charges, a modified charge flow path CFPM, in which the charges charged via the bridge wiring pattern ML3B move to the substrate 110, may be formed. In this case, because the charges charged in the target wiring pattern ML4L is not transferred to the gate electrode 150, the gate dielectric layer 140, or a channel region, that is, the active region FA, a break in the gate dielectric layer 140, a burn in the channel region, that is, the active region FA, or a burn in the gate electrode 150 may not occur, and failures in the semiconductor device 100a illustrated in FIG. 5A may not occur.

FIGS. 9A through 9C may illustrate a process of manufacturing a semiconductor device (S130) using the semiconductor device layout S120 designed based on the DRM S20 described with reference to FIGS. 1A through 1D, or a process of manufacturing a semiconductor device using a simulation (S150) using the designed semiconductor device layout S120. FIG. 10 may include a process of manufacturing a semiconductor device (S130) using the semiconductor device layout S120 designed based on the updated DRM S20 described with reference to FIGS. 1A through 1D.

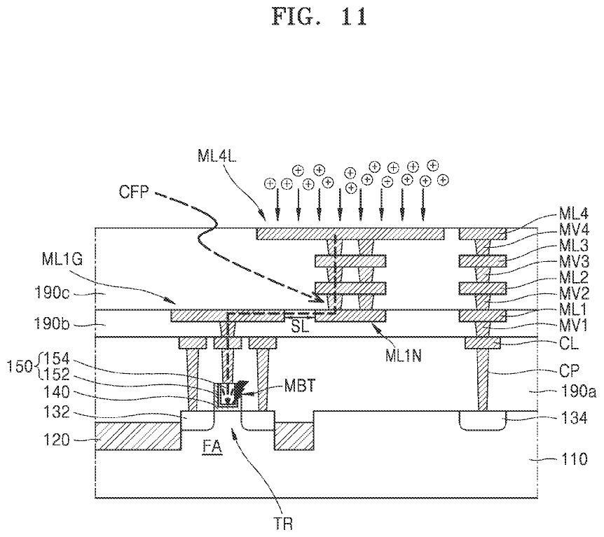

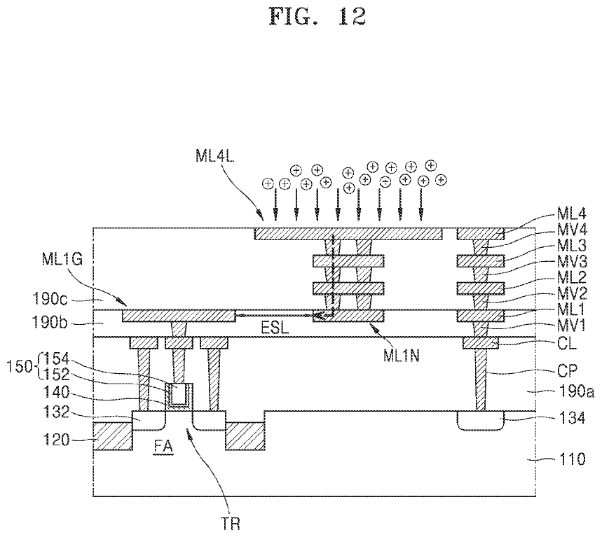

FIGS. 11 and 12 are cross-sectional views of a manufacturing method of semiconductor devices, and cross-sectional views of semiconductor devices, according to embodiments. FIGS. 11 and 12 are cross-sectional views describing, with reference to FIGS. 1A through 3 and 6 and 7 together, a process of manufacturing the semiconductor device 200 illustrated in FIG. 7 using the updated DRM S20 after the failure evaluation is performed (S160) on the semiconductor device 2 illustrated in FIG. 6.

Referring to FIG. 11, after the substrate trench is formed in the substrate 110, the device isolation layer 120 defining the active region FA while filling at least a portion of the substrate trench is formed, and the first impurity region 132 and the second impurity region 134 may be formed in a portion in the upper side of the substrate 110. The gate dielectric layer 140 and the gate electrode 150 may be sequentially formed on the active region FA.

On the substrate 110, the contact plugs CP connected to the pair of first impurity regions 132, the second impurity region 134, and the gate electrode 150, the connection conductive lines CL connected to the contact plugs CP, and the first preliminary inter-wiring insulating layer 190a surrounding the gate electrode 150, the connection conductive lines CL, and the contact plugs CP, may be formed.

On the connection conductive lines CL and the first preliminary inter-wiring insulating layer 190a, the second preliminary inter-wiring insulating layer 190b surrounding the plurality of first wiring vias MV1, the plurality of first wiring patterns ML1, the plurality of first wiring vias MV1, and the plurality of first wiring patterns ML1 may be formed. At least one of the plurality of first wiring patterns ML1 may be the gate wiring pattern ML1G electrically connected to the gate electrode 150 via at least one of the first wiring vias MV1. At least one of the plurality of first wiring patterns ML1 may be adjacent to the gate wiring pattern ML1G with a first separation interval SL therebetween, and may include the first adjacent wiring pattern ML1N electrically floating from the substrate 110.

On the plurality of second wiring patterns ML2 and the second preliminary inter-wiring insulating layer 190b, the plurality of second wiring vias MV2, the plurality of second wiring patterns ML2, the plurality of third wiring vias MV3, the plurality of third wiring patterns ML3, the plurality of fourth wiring vias MV4, the plurality of fourth wiring patterns ML4, and the third preliminary inter-wiring insulating layer 190c surrounding the plurality of second wiring vias MV2, the plurality of second wiring patterns ML2, the plurality of third wiring vias MV3, the plurality of third wiring patterns ML3, the plurality of fourth wiring vias MV4, and the plurality of fourth wiring patterns ML4 may be formed. At least one of the plurality of fourth wiring patterns ML4 may include the target wiring pattern ML4L electrically floated from the substrate 110 and having a relatively large area.

During the process of forming the third preliminary inter-wiring insulating layer 190c, charges may be charged in the target wiring pattern ML4L. For example, the target wiring pattern ML4L may be charged by plasma used in the process of forming the third preliminary inter-wiring insulating layer 190c. The first adjacent wiring pattern ML1N and the first adjacent wiring pattern ML1N electrically connected to the target wiring pattern ML4L may be floated from the substrate 110. Accordingly, in the process of forming the third preliminary inter-wiring insulating layer 190c, charges charged in the target wiring pattern ML4L may move to the first adjacent wiring pattern ML1N and also charge the first adjacent wiring pattern ML1N. When a separation interval between the first adjacent wiring pattern ML1N and the gate wiring pattern ML1G has the first separation interval SL, which is relatively small, charges charged in the first adjacent wiring pattern ML1N may cause a coupling effect in the gate wiring pattern ML1G, and the charge flow path CFP from the target wiring pattern ML4L to the gate electrode 150, the gate dielectric layer 140, or the channel region, that is, the active region FA, may be generated. In this case, a break in the gate dielectric layer 140, a burn in the channel region, that is, an active region FA, or a burn in the gate electrode 150 may occur, and failures may occur in the semiconductor device 2 illustrated in FIG. 6.

Referring to FIG. 12, the gate wiring pattern ML1G and the first adjacent wiring pattern ML1N may be formed to have a second separation interval ESL greater than the first separation interval SL illustrated in FIG. 11.

When, in the process of forming the third preliminary inter-wiring insulating layer 190c, even though charges are charged in the target wiring pattern ML4L, the gate wiring pattern ML1G and the first adjacent wiring pattern ML1N are arranged apart from each other with the second separation interval ESL, which is sufficiently large, therebetween, a coupling effect may not occur in the gate wiring pattern ML1G even when charges charged in the target wiring pattern ML4L moves to the first adjacent wiring pattern ML1N. In this case, because the charges charged in the target wiring pattern ML4L are not transferred to the gate electrode 150, the gate dielectric layer 140, or a channel region, that is, the active region FA, a break in the gate dielectric layer 140, a burn in the channel region, that is, the active region FA, or a burn in the gate electrode 150 may not occur, and failures in the semiconductor device 200 illustrated in FIG. 7 may not occur.

FIG. 11 may illustrate a process of manufacturing a semiconductor device (S130) using the semiconductor device layout S120 designed based on the DRM S20 described with reference to FIGS. 1A through 1D, or a process of manufacturing a semiconductor device using a simulation (S150) using the designed semiconductor device layout S120. FIG. 12 may include a process of manufacturing a semiconductor device (S130) using the semiconductor device layout S120 designed based on the updated DRM S20 described with reference to FIGS. 1A through 1D.

Referring to FIGS. 1A through 12, the manufacturing method of a semiconductor device according to embodiments may include redesigning or correcting the semiconductor device layout (S110) based on the updated DRM S20 by storing, in the DRM S20, the updated design rule by changing or adding the design rule applied to a periphery of a location where failures have occurred, manufacturing the semiconductor device (S130), and shipping out the product (S300). Therefore, it may be possible to manufacture a semiconductor device while preventing or reducing the occurrence of failures.

While the inventive concept has been particularly shown and described with reference to embodiments thereof, it will be understood that various changes in form and detail may be made therein without departing from the spirit and scope of the inventive concept as defined by the following claims.

What is claimed is:

1. A method of manufacturing a semiconductor device, comprising:
designing a semiconductor device layout using a design rule manual (DRM) in which design rules are recorded;
performing a failure evaluation of a failure including at least one gate structure failure of a semiconductor device manufactured using the designed semiconductor device layout;
updating the DRM by updating the design rules recorded in the DRM, based on a result of the failure evaluation;
redesigning the semiconductor device layout using the updated DRM; and
manufacturing the semiconductor device using the redesigned semiconductor device layout.

2. The method of claim 1, wherein the semiconductor device comprises:
a substrate including an active region defined by a device isolation layer;
a pair of first impurity regions and a second impurity region arranged apart from each other on a portion of an upper side of the substrate;
a gate electrode arranged on the active region between the pair of first impurity regions;
a gate dielectric layer arranged between the active region and the gate electrode; and
a wiring structure including a plurality of wiring patterns and a plurality of wiring vias,
wherein the gate structure failure comprises a break of the gate dielectric layer, a burn of the active region, or a burn of the gate electrode.

3. The method of claim 2, wherein the plurality of wiring patterns comprise:
a plurality of first wiring patterns arranged at a first vertical level, a plurality of second wiring patterns arranged at a second vertical level that is higher than the first vertical level, a plurality of third wiring patterns arranged at a third vertical level that is higher than the second vertical level, and a plurality of fourth wiring patterns arranged at a fourth vertical level that is higher than the third vertical level,
wherein the plurality of first wiring patterns comprise a gate wiring pattern electrically connected to the gate electrode, a first adjacent wiring pattern adjacent to the gate wiring pattern, and a first connection wiring pattern arranged between the fourth wiring patterns and the second impurity region and configured to electrically connect the fourth wiring patterns to the second impurity region,
wherein the plurality of second wiring patterns comprise a second adjacent wiring pattern arranged between the first adjacent wiring pattern and the fourth wiring patterns and configured to electrically connect the fourth wiring patterns to the first adjacent wiring pattern, and a second connection wiring pattern arranged between the fourth wiring patterns and the second impurity region and configured to electrically connect the fourth wiring patterns to the second impurity region, and
wherein the plurality of third wiring patterns comprise a target wiring pattern arranged between the first adjacent wiring pattern and the fourth wiring patterns and configured to electrically connect the fourth wiring patterns to the first adjacent wiring pattern, and a third connection wiring pattern arranged between the fourth wiring patterns and the second impurity region and configured to electrically connect the fourth wiring patterns to the second impurity region.

4. The method of claim 3, wherein updating the DRM comprises:
when an area of the target wiring pattern is greater than a threshold maximum area, changing a design rule among the design rules such that a separation interval between the gate wiring pattern and the first adjacent wiring pattern is changed to a second separation interval that is greater than the first separation interval; and
storing the changed design rule in the DRM.

5. The method of claim 3, wherein updating the DRM comprises:
when an area of the target wiring pattern is greater than a threshold maximum area, changing a design rule among the design rules such that at least one of a first bridge wiring pattern configured to connect a first adjacent connection pattern to a fourth connection wiring pattern and a second bridge wiring pattern configured to connect a second adjacent connection pattern to the second connection wiring pattern is added; and
storing the changed design rule in the DRM.

6. The method of claim 5, wherein the area of the target wiring pattern is about equal to a total area of the third wiring patterns connected to each other at an identical vertical level among the plurality of third wiring patterns.

7. The method of claim 5, wherein the threshold maximum area of the target wiring pattern is about 300 μm².

8. The method of claim 2, wherein the active region is a fin-type active region, in which an upper portion of the active region protrudes in a fin shape over the device isolation layer.

9. The method of claim 1, wherein performing the failure evaluation comprises:
manufacturing the semiconductor device by performing wafer processing using the redesigned semiconductor device layout;
performing a test of inspecting electrical characteristics of the manufactured semiconductor device; and
performing the failure evaluation of the manufactured semiconductor device using a result of the test.

10. The method of claim 1, wherein performing the failure evaluation comprises:
performing a simulation of manufacturing the semiconductor device using the redesigned semiconductor device layout; and
performing the failure evaluation of the semiconductor device manufactured using the simulation.

11. A method of manufacturing a semiconductor device, comprising:
designing a semiconductor device layout using a design rule manual (DRM), in which design rules are recorded;
manufacturing the semiconductor device by performing a wafer processing using the designed semiconductor device layout;
performing a test of inspecting electrical characteristics of the manufactured semiconductor device;
performing a failure evaluation of a break of a gate dielectric layer, a burn of an active region, or a burn of a gate electrode, which are included in the semiconductor device, based on a result of the test of the manufactured semiconductor device;
updating the DRM by updating the design rules recorded in the DRM based on the result of the failure evaluation;
redesigning the semiconductor device layout using the updated DRM; and
manufacturing the semiconductor device using the redesigned semiconductor device layout.

12. The method of claim 11, wherein the semiconductor device comprises:
a substrate including an active region defined by a device isolation layer;
a pair of first impurity regions and a second impurity region arranged apart from each other on a portion of an upper side of the substrate;
a gate electrode arranged on the active region between the pair of first impurity regions, a gate dielectric layer arranged between the active region and the gate electrode, and a wiring structure including a plurality of wiring patterns and a plurality of wiring vias,
wherein the plurality of wiring patterns comprise:
a plurality of first wiring patterns, arranged on the gate electrode, including a gate wiring pattern electrically connected to the gate electrode, a first adjacent wiring pattern adjacent to the gate wiring pattern, and a plurality of first wiring patterns, on the second impurity region, wherein one of the first impurity regions is electrically connected to the second impurity region;
a plurality of second wiring patterns arranged on a higher vertical level than the plurality of first wiring patterns, and including a second adjacent wiring pattern electrically connected to a first adjacent connection pattern on the first adjacent wiring pattern, and a second connection wiring pattern, on the first connection wiring pattern, electrically connected to the first connection wiring pattern;
a plurality of third wiring patterns arranged on a higher vertical level than the plurality of second wiring patterns, and including a third adjacent wiring pattern, on the second adjacent wiring pattern, electrically connected to a second adjacent connection pattern, and a third connection wiring pattern, on the second connection wiring pattern, electrically connected to the second connection wiring pattern; and
a plurality of fourth wiring patterns arranged at a higher vertical level than the plurality of third wiring patterns, and respectively and electrically connected to a target wiring pattern and the third connection wiring pattern on the target wiring pattern and the third connection wiring pattern.

13. The method of claim 12, wherein designing the semiconductor device layout comprises designing the semiconductor device layout such that a separation interval between the gate wiring pattern and the first adjacent wiring pattern is set to a first separation interval,
wherein updating the DRM comprises, when an area of the target wiring pattern is greater than a threshold maximum area, changing a design rule among the design rules such that the separation interval between the gate wiring pattern and the first adjacent wiring pattern is set to a second separation interval that is greater than the first separation interval, and
wherein manufacturing the semiconductor device comprises manufacturing the semiconductor device by setting the separation interval between the gate wiring pattern and the first adjacent wiring pattern to the second separation interval.

14. The method of claim 13, wherein designing the semiconductor device layout comprises designing the semiconductor device layout such that, at respectively identical vertical levels, the first adjacent wiring pattern and the first connection wiring pattern are arranged apart from each other, the second adjacent wiring pattern and the second connection wiring pattern are arranged apart from each other, and a target wiring pattern and the third connection wiring pattern are arranged apart from each other,
wherein updating the DRM comprises, when the area of the target wiring pattern is greater than the threshold maximum area, changing the design rule such that at least one of a first bridge wiring pattern configured to connect the first adjacent connection pattern to the fourth connection wiring pattern and a second bridge wiring pattern configured to connect the second adjacent connection pattern to the second connection wiring pattern is added at respectively identical vertical levels, and storing the changed design rule in the DRM, and
wherein manufacturing of the semiconductor device comprises manufacturing the semiconductor device such that at least one of a first bridge wiring pattern configured to connect the first adjacent connection pattern to the first connection wiring pattern and a second bridge wiring pattern configured to connect the second adjacent connection pattern to a second connection wiring pattern is included in the semiconductor device.

15. The method of claim 12, wherein the active region, the pair of first impurity regions, the gate dielectric layer, and the gate electrode comprise a transistor, and
the transistor includes a FinFET, in which the active region includes a fin-type active region.

16. The method of claim 12, further comprising:
a plurality of contact plugs connected to the pair of first impurity regions, the second impurity region, and the gate electrode; and
a plurality of connection conductive lines connected to the contact plugs.

17. The method of claim 16, wherein the plurality of wiring vias comprise:
a plurality of first wiring vias configured to connect at least a portion of the plurality of first wiring patterns to the connection conductive lines;
a plurality of second wiring vias connected to lower surfaces of the plurality of second wiring patterns and configured to electrically connect the plurality of second wiring patterns to the plurality of first wiring patterns;
a plurality of third wiring vias connected to lower surfaces of the plurality of third wiring patterns and configured to electrically connect the plurality of third wiring patterns to the plurality of second wiring patterns; and
a plurality of fourth wiring vias connected to lower surfaces of the fourth wiring patterns and configured to electrically connect the target wiring pattern to the plurality of third connection patterns.

18. A method of manufacturing a semiconductor device, comprising:
designing a semiconductor device layout including a substrate including an active region defined by a device isolation layer, a pair of first impurity regions and a second impurity region arranged apart from each other on a portion of an upper side of the substrate, a gate electrode arranged on the active region between the pair of first impurity regions, a gate dielectric layer arranged between the active region and the gate electrode, and a wiring structure including a plurality of wiring patterns and a plurality of wiring vias, using a design rule manual (DRM) in which design rules are recorded;
manufacturing a semiconductor device by performing a simulation using the designed semiconductor device layout;
performing a failure evaluation of a break of a gate dielectric layer, a burn of an active region, or a burn of a gate electrode, which are included in the semiconductor device manufactured using the simulation;
updating the DRM by changing regulations specified in the design rules recorded in the DRM, based on a result of the failure evaluation;
redesigning the semiconductor device layout using the updated DRM; and
manufacturing the semiconductor device by performing wafer processing using the redesigned semiconductor device layout,
wherein the plurality of wiring patterns comprise a plurality of first wiring patterns arranged at a first vertical level, a plurality of second wiring patterns arranged at a second vertical level that is higher than the first vertical level, a plurality of third wiring patterns arranged at a third vertical level that is higher than the second vertical level, and a plurality of fourth wiring patterns arranged at a fourth vertical level that is higher than the third vertical level,
wherein the plurality of first wiring patterns comprise a gate wiring pattern electrically connected to the gate electrode, a first adjacent wiring pattern adjacent to the gate wiring pattern, and a first connection wiring pattern arranged between the fourth wiring patterns and the second impurity region and configured to electrically connect the fourth wiring patterns to the second impurity region,
wherein the plurality of second wiring patterns comprise a second adjacent wiring pattern arranged between the first adjacent wiring pattern and the fourth wiring patterns and configured to electrically connect the fourth wiring patterns to the first adjacent wiring pattern, and a second connection wiring pattern arranged between the fourth wiring patterns and the second impurity region and configured to electrically connect the fourth wiring patterns to the second impurity region, and
wherein the plurality of third wiring patterns comprise a target wiring pattern arranged between the first adjacent wiring pattern and the fourth wiring patterns and configured to electrically connect the fourth wiring patterns to the first adjacent wiring pattern, and a third connection wiring pattern arranged between the fourth wiring patterns and the second impurity region and configured to electrically connect the fourth wiring patterns to the second impurity region.

19. The method of claim 18, wherein updating the DRM comprises:
when an area of the target wiring pattern is greater than a threshold maximum area, changing a design rule among the design rules so that a separation interval between the gate wiring pattern and the first adjacent wiring pattern is a second separation interval that is greater than the first separation interval, and
wherein manufacturing the semiconductor device comprises manufacturing the semiconductor device such that the separation interval between the gate wiring pattern and the first adjacent wiring pattern has the second separation interval that is greater than the first separation interval, which is an interval between the gate wiring pattern included in the semiconductor device manufactured using the simulation and the first adjacent wiring pattern.

20. The method of claim 19, wherein designing the semiconductor device layout comprises:
designing the semiconductor device layout such that, at respectively identical vertical levels, the first adjacent wiring pattern and the first connection wiring pattern are arranged apart from each other, the second adjacent wiring pattern and the second connection wiring pattern are arranged apart from each other, and the target wiring pattern and the third connection wiring pattern are arranged apart from each other,
wherein updating the DRM comprises:
when the area of the target wiring pattern is greater than the threshold maximum area, changing the design rule such that at least one of a first bridge wiring pattern configured to connect a first adjacent connection pattern to a fourth connection wiring pattern and a second bridge wiring pattern configured to connect the second adjacent connection pattern to the second connection wiring pattern is added at respectively identical vertical levels, and storing the changed design rule in the DRM, and
wherein manufacturing the semiconductor device comprises manufacturing the semiconductor device such that at least one of the first bridge wiring pattern and the second bridge wiring pattern is included in the semiconductor device.
